(19) United States
(12) Patent Application Publication
(10) Pub. No.: US 2026/0287365 A1
(43) Pub. Date: Sep. 24, 2026

(54) SYSTEM

(71) Applicant: SoftBank Group Corp., Tokyo (JP)

(72) Inventor: Yuya ONO, Tokyo (JP)

(73) Assignee: SoftBank Group Corp., Tokyo (JP)

(21) Appl. No.: 19/567,036

(22) Filed: Mar. 14, 2026

(30) Foreign Application Priority Data
Mar. 19, 2025 (JP) 2025-045226

(51) Int. Cl. G01C 21/20; G06F 16/3329

(52) U.S. Cl. CPC G01C 21/206; G06F 16/33295

(57) ABSTRACT

A system includes a processor that is configured to receive, from a user terminal, location information and movement needs of a user, generate, using a generative artificial intelligence model, a prompt sentence that instructs analysis of the received information to extract relevant information, analyze the received information based on the generated prompt sentence using the generative artificial intelligence model, and extract relevant information, classify the relevant information into appropriate services based on an analysis result, acquire real-time mobile object information by using an external application programming interface, and notify the user of the real-time mobile object information, propose a customized movement plan by using the generative artificial intelligence model, calculate an optimal route within a facility, and guide the user along the optimal route, acquire information on surrounding facilities, and provide the information on the surrounding facilities to the user, provide appropriate support information when a problem occurs.

### CROSS-REFERENCE TO RELATED APPLICATION

This application is based on and claims priority under 35 USC 119 from Japanese Patent Application No. 2025-045226 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional mobility assistance and information-provision systems used in transportation facilities and large-scale complexes are typically designed as siloed solutions that separately provide route guidance, transportation status, facility information, and customer support. In many cases, these systems rely on static rule-based logic, require manual selection of a service category by a user, and cannot flexibly interpret unstructured user input such as free-text travel needs or complex combinations of constraints. As a result, a user is required to repeatedly input similar information into multiple applications or interfaces, manually determine which service is relevant, and independently compare or combine the obtained information. Furthermore, conventional systems generally do not incorporate real-time emotional state recognition of the user and therefore cannot adapt the style or content of service responses according to the user's stress level, anxiety, or satisfaction. In addition, there is insufficient integration between real-time mobile object information obtained from external APIs, customized movement planning, indoor route calculation, and contextual support for trouble situations, such as delays, cancellations, or lost items. This leads to fragmented user experiences, increased cognitive load on the user, and inefficient use of available information and services, particularly in time-sensitive travel scenarios and complex facility environments.

### SUMMARY

In order to solve the above-described problems, a system according to one embodiment of the present invention comprises a processor configured to cooperatively execute multiple integrated functions by utilizing a generative artificial intelligence model and external information sources. The processor is configured to receive, from a user terminal, location information and movement needs of a user expressed, for example, as structured data or natural language text. The processor is further configured to generate, using the generative artificial intelligence model, a prompt sentence that instructs how to analyze the received information in order to extract relevant information, to analyze the received information based on the generated prompt sentence, and to extract relevant information related to mobility, facility usage, or support needs. The processor is configured to classify the extracted relevant information into appropriate services on the basis of the analysis result, such that a mobility support service, a facility information service, or a support service for trouble situations is automatically selected without requiring the user to explicitly choose a service category. The processor is configured to acquire real-time mobile object information, such as transportation schedules, delays, or gate changes, from an external application programming interface, and to notify the user of the acquired real-time mobile object information in a timely manner. The processor is also configured to propose a customized movement plan, including for example recommended timing and sequence of actions, by using the generative artificial intelligence model in accordance with the user's current context. Moreover, the processor is configured to calculate an optimal route within a facility and guide the user along this route by transmitting route information to the user terminal. The processor is further configured to acquire information on surrounding facilities, such as restaurants, shops, or lounges, and to provide this information to the user as part of the integrated guidance. Additionally, the processor is configured to provide appropriate support information when a problem occurs, such as a delay, cancellation, or lost baggage, and to recognize an emotion of the user and adjust a style, content, or intensity of the service based on the recognized emotion. By implementing these means in an integrated manner, the system reduces the user's cognitive burden, automatically maps user needs to suitable services, and enables context-aware and emotion-aware mobility assistance that unifies real-time information acquisition, route guidance, facility information provisioning, and trouble support.

The term “system” refers to an integrated arrangement of hardware, software, and communication components configured to perform the functions recited in the claims, including receiving user-related information, processing the information, and providing outputs to a user terminal.

The term “processor” refers to one or more hardware processing units, such as a central processing unit (CPU), a graphics processing unit (GPU), a digital signal processor (DSP), or any combination thereof, executing program instructions to perform the operations described in the claims.

The term “user terminal” refers to an electronic device operated by a user, such as a smartphone, tablet, laptop computer, wearable device, or any other client device, capable of transmitting information to the system and receiving information from the system via a communication network.

The term “location information” refers to information indicating a geographic position or an indoor position of the user or the user terminal, including, for example, coordinates, an airport or station identifier, a building or floor identifier, or other data that can be used to determine a current position.

The term “movement needs” refers to requirements or intentions of a user relating to movement or travel, including, for example, destination, desired arrival time, constraints on route selection, preferences regarding transportation modes, and requests for assistance or guidance.

The term “generative artificial intelligence model” refers to a machine learning model configured to generate text or other structured outputs in response to input data or prompts, such as a large language model or other generative model capable of performing natural language analysis and content generation.

The term “prompt sentence” refers to a text string or structured instruction generated for input to the generative artificial intelligence model, the text string or structured instruction specifying how the generative artificial intelligence model should analyze given information or what type of information should be extracted.

The term “analyze” refers to processing input data to determine structure, meaning, or semantic relationships, including, for example, parsing natural language, identifying entities or attributes, classifying content, and extracting relevant elements based on a defined objective.

The term “relevant information” refers to information that is determined, based on analysis of received data, to be pertinent to one or more services provided by the system, such as mobility assistance, facility guidance, or support for trouble situations.

The term “classify” refers to assigning analyzed or extracted information to one or more predefined categories or service types according to rules, learned models, or decision criteria implemented by the processor.

The term “service” refers to a functional module or capability provided by the system, such as mobility support, real-time information notification, route guidance, facility information provision, or trouble support, which processes user-related information and outputs results to the user.

The term “real-time mobile object information” refers to information relating to the current or predicted status of moving entities, including, for example, vehicles, flights, trains, buses, or other means of transportation, such as departure and arrival times, delays, gate changes, or cancellations.

The term “external application programming interface” refers to an interface provided by an external system or service that allows the processor to send requests and receive responses over a network, thereby obtaining data such as real-time mobile object information from a system operated by another entity.

The term “notify the user” refers to causing information to be presented to the user via the user terminal, including, for example, displaying text or graphics, generating sound or vibration alerts, or otherwise outputting information perceivable by the user.

The term “customized movement plan” refers to a plan generated for an individual user that includes one or more recommended actions or schedules related to movement or travel, the plan being determined based on user-specific information such as current position, movement needs, time constraints, or preferences.

The term “facility” refers to a physical environment in which the user moves, such as an airport, railway station, shopping mall, complex building, or similar structure, including its internal areas, routes, and associated equipment.

The term “optimal route” refers to a path from a starting point to a destination within a facility that satisfies one or more optimization criteria, such as shortest distance, minimum estimated time, least number of transfers, or adherence to accessibility constraints, as determined by the processor.

The term “guide the user” refers to providing route-related information to the user, including, for example, map data, turn-by-turn instructions, or stepwise directions, so that the user can follow the indicated route within the facility.

The term “surrounding facilities” refers to establishments, services, or points of interest located in the vicinity of the user within or near the facility, including, for example, restaurants, shops, lounges, restrooms, information counters, or other amenity locations.

The term “support information” refers to information that assists the user in resolving a problem or trouble situation, including, for example, procedural steps, contact points, counter locations, required documents, or links to relevant external resources.

The term “problem” refers to an event or situation that adversely affects the user's planned movement or use of services, including, for example, transportation delays or cancellations, missed connections, lost baggage, or other disruptions.

The term “emotion of the user” refers to an affective state of the user, such as stress, anxiety, frustration, satisfaction, or calmness, which can be inferred from user input, interaction patterns, biometric data, or other observable indicators.

The term “recognize an emotion” refers to determining, estimating, or classifying the emotional state of the user using one or more algorithms or models based on input signals or behavioral data associated with the user.

The term “adjust a service based on the recognized emotion” refers to modifying one or more aspects of how a service is provided, such as the content, tone, level of detail, frequency of notifications, or prioritization of information, in response to the recognized emotional state of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

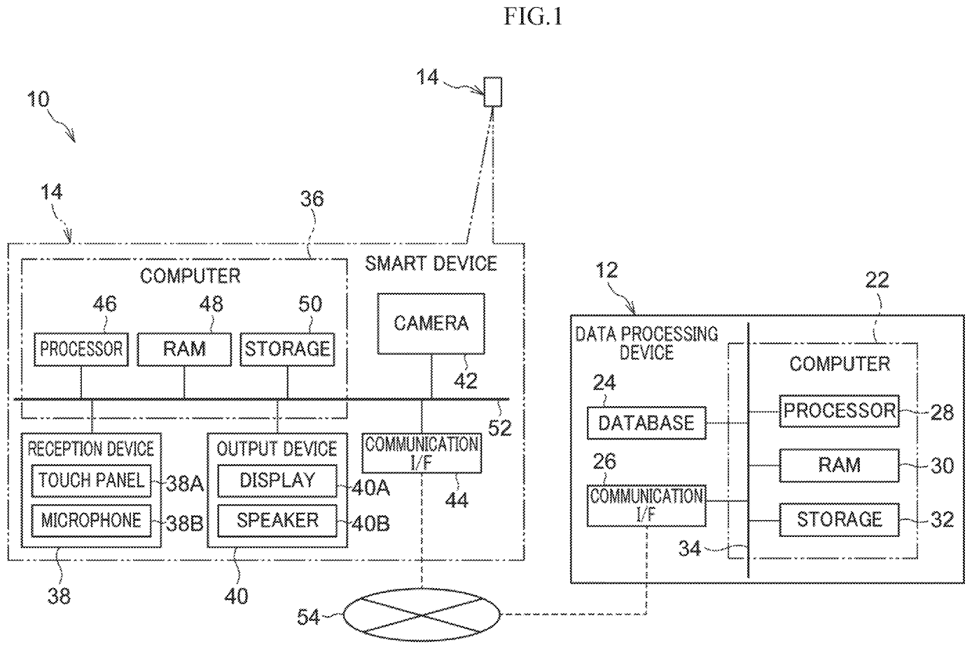

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

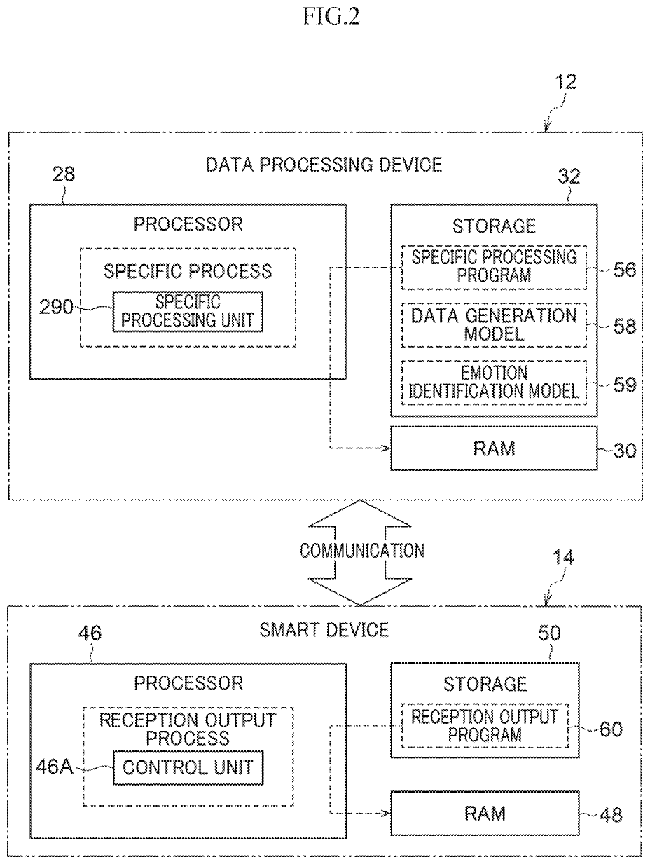

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional mobility support systems that provide transportation information and indoor guidance typically rely on rule-based engines and statically defined workflows. Such systems are often configured with fixed logic for mapping user inputs (for example, origin, destination, and desired arrival time) to transportation options and facility routes. As a result, these systems suffer from several technical limitations in terms of computer technology. First, existing systems generally treat heterogeneous mobility-related data flows—such as real-time transportation data from external interfaces, indoor positioning data, and user-specific requirements—as separate pipelines. The server-side components often lack a unified mechanism for dynamically classifying and routing incoming information to appropriate services, leading to duplicated processing, inefficient resource usage, and increased latency. This fragmented approach can cause unnecessary network calls, redundant database queries, and multiple passes of similar computations, thereby degrading system throughput and responsiveness.

Second, conventional architectures often place the burden of generating user-facing guidance on the client-side application, which must assemble human-readable instructions from raw data and simple templates. This design requires complex client logic and extensive UI-side condition handling, and it does not adapt well to changing patterns of user behavior or context. The client application is forced to include extensive conditional branches for different mobility scenarios, which increases code size, makes maintenance difficult, and can lead to inconsistent behavior across different devices.

Third, although some systems attempt to personalize travel plans, such personalization is typically restricted to pre-programmed profiles and simple preference flags. The server usually does not maintain a flexible, machine-readable history of user interactions that can be fed back into the core processing pipeline. As a consequence, the system cannot effectively refine its prompt generation or adjust its presentation logic over time. This results in a static user experience, in which the same underlying algorithms are repeatedly applied regardless of the user's historical behavior, reducing the effective utility of the system.

Fourth, integrating large-scale natural language processing and planning capabilities into mobility support systems is non-trivial. Naively calling a generative AI model from application code without a carefully designed prompt-generation and response-integration pipeline can lead to unpredictable outputs, inconsistent data structures, and additional processing overhead to clean up and normalize responses. Without a structured way to generate prompt sentences and to convert model outputs into structured, machine-usable plans, the system cannot reliably incorporate generative AI into its core data processing, and server performance may degrade due to excessive post-processing and error handling. Fifth, indoor navigation components are typically implemented as standalone modules that periodically compute routes based solely on instantaneous positions. When a user deviates from a suggested route, existing systems frequently recompute paths in isolation, without coordinating with higher-level movement plans or external services. This leads to disconnected behavior where the route engine and the plan-generation engine operate independently, causing inconsistent guidance and unnecessary recomputation on the server and the client, as well as suboptimal utilization of network and processing resources. Accordingly, there is a need for an improved server-centric system architecture that: (i) unifies the handling of mobility-related data streams, (ii) programmatically generates and refines prompt sentences for a generative AI model, (iii) converts natural language outputs into structured movement plans and route guidance, (iv) adaptively classifies services and adjusts behavior based on user interaction history, and (v) tightly couples indoor routing updates with AI-based plan regeneration. Such an architecture should improve computational efficiency, reduce redundant processing, provide more consistent server-controlled behavior across terminals, and enhance the overall performance and scalability of mobility support systems as computer technology.

The specific processing by the specific processing unit 290 of the data processing device 12 in Example 1 is realized by the following means.

The present invention provides a server comprising a processor configured to receive position-related information and movement-related requests from a user terminal, generate structured prompt sentences based on the received information, and transmit the prompt sentences to a generative AI model, while also integrating outputs of the generative AI model with dynamic transportation data and indoor route computation. This enables a unified, server-centric processing pipeline that reduces redundant client logic, improves efficiency of data classification and movement plan generation, and enhances consistency and adaptability of mobility guidance across diverse computing environments.

The term “system” refers to an integrated combination of hardware components, software components, and communication interfaces that cooperate to execute mobility-related information processing, including servers, storage units, networks, and user terminals.

The term “processor” refers to a hardware computation unit, such as a central processing unit or a processing core, capable of executing instructions stored in a memory to perform the functions described in the claims.

The term “user terminal” refers to an information processing apparatus operated by a user, including but not limited to a portable communication device, a tablet device, or a general-purpose computing device capable of transmitting and receiving data over a communication network.

The term “position-related information” refers to data indicative of a physical or geographical location of an object or a user, including absolute coordinates, relative positions, floor levels, and indoor positions derived from positioning technologies.

The term “movement-related requests” refers to user-originated requests that specify conditions or preferences for movement, such as departure locations, destinations, desired arrival times, transportation constraints, or route preferences.

The term “prompt sentence” refers to a structured natural language or machine-readable text generated by the processor for input to a generative AI model, the text specifying analysis instructions, contextual information, or constraints for the generative AI model.

The term “generative AI model” refers to a machine-learned information processing model, such as a neural network-based language model, configured to generate natural language text or structured outputs from input text including a prompt sentence.

The term “natural language analysis” refers to processing performed by the generative AI model to interpret, classify, or extract meaning from input text expressed in a human language.

The term “movement plan” refers to a plan or schedule describing one or more actions for movement from a starting position to a destination, including stepwise instructions, estimated times, and intermediate waypoints.

The term “service category” refers to a classification type used by the system to group mobility-related processing functions, such as transportation information services, indoor navigation services, user support services, or facility information services.

The term “dynamic information related to a mobile object” refers to time-varying data associated with a moving entity, including schedule updates, delays, cancellations, gate changes, and traffic conditions obtained from an external interface.

The term “external communication interface” refers to a hardware and software combination that enables the processor to exchange data with external systems or services, such as communication protocols, network adapters, and application programming interfaces.

The term “movement-related information” refers to processed and structured data concerning movement, derived from analysis results, dynamic information, and user requests, and suitable for presentation to a user terminal.

The term “structured data format” refers to a machine-interpretable representation of information, such as a record, list, or hierarchical object encoded in a standard format including but not limited to a key-value structure.

The term “indoor positioning unit” refers to a combination of hardware, software, and algorithms that estimate an indoor location using technologies such as wireless signals, sensor measurements, or beacon identifiers.

The term “route data” refers to digital data describing paths within a facility, including nodes, edges, connectivity information, and associated attributes used to compute routes.

The term “route search process” refers to a computational procedure that determines a path between two or more points using route data, by applying a search algorithm such as a shortest-path or least-cost algorithm.

The term “guidance information” refers to information for assisting a user in moving from a current position to a destination, including map displays, textual instructions, directional indicators, and timing suggestions.

The term “stepwise action instructions” refers to a sequence of discrete instructions describing individual actions to be performed by a user in order, each step specifying a partial movement or operation.

The term “time-series procedure information” refers to a set of action instructions arranged along a temporal axis, each associated with a time or time interval to be followed in sequence.

The term “operation history information” refers to data that records user interactions with the system, including input operations, selections, confirmations, and navigation actions.

The term “response history information” refers to data that records outputs or responses presented to the user by the system, including generated movement plans, notification contents, and guidance messages.

The term “service-identification prompt sentence” refers to a prompt sentence generated to cause the generative AI model to identify or estimate a type and priority of a service corresponding to input information.

The term “estimation result” refers to an output from the generative AI model or another computation indicating a predicted service type, priority, or other inferred attribute related to the input.

The term “movement state of the user” refers to a representation of the user's current and recent movement, including location history, speed, direction, and progress toward a destination.

The term “predetermined threshold” refers to a reference value stored in the system and used to determine whether a deviation or change is significant enough to trigger a specific processing, such as route recalculation.

The term “destination” refers to a target location that the user intends to reach, including but not limited to a point within a facility, a transportation access point, or a service area.

In one embodiment, a server, a terminal, and a user cooperate to implement the claimed system. The server includes one or more physical processors, a main memory, a non-volatile storage unit, and a network interface. For example, the server uses a general-purpose computing platform, such as a rack-mounted computer equipped with a multi-core central processing unit, a volatile memory device, a non-volatile memory device, and a communication interface connected to a packet-switched network. The server executes an operating system and server-side application software implemented as executable instructions stored on the non-volatile memory device and loaded into the volatile memory device.

The terminal includes a portable information processing device such as a smartphone or tablet. For example, the terminal uses a mobile device equipped with a central processing unit, a graphical processing unit, a touch-sensitive display, a wireless communication module, a positioning sensor module, and a local storage unit. The terminal executes a mobile operating system, such as a system for handheld devices, and runs an application program installed from an application distribution platform.

The user operates the terminal to input movement-related requests and to view guidance information. The user activates a mobile application on the terminal, and the terminal initializes user interface components, internal data structures, and communication modules.

The terminal constructs data objects for position-related information and movement-related requests, including current location, destination, desired arrival time, and preference parameters such as walking speed or avoidance of stairs.

The server receives, via the network interface, position-related information and movement-related requests transmitted from the terminal. The server stores these in a structured data store, for example a relational database management system or a key-value database, as records that include fields for a user identifier, timestamps, location coordinates, movement constraints, and preference settings. The server uses a data access layer implemented in application software to read and write these records.

The server generates a prompt sentence for a generative AI model by executing a prompt-construction module. The prompt-construction module uses a template-based algorithm and a feature-extraction algorithm. The server parses the received position-related information and movement-related requests into a set of normalized features, including current time, current facility, origin coordinates, destination coordinates, transportation schedule parameters, and preference flags. The server stores these features in an intermediate representation, such as a structured object in memory.

The server applies a template selection algorithm that chooses a prompt template based on the type of request and the available data. For example, if the request involves indoor movement within a facility, the server selects a template for indoor movement planning; if the request involves multi-modal transportation, the server selects a different template. The server then performs a token substitution process in which placeholders in the template are replaced with string representations of the extracted features. The server thus generates a concrete prompt sentence that encodes both context and explicit instructions to the generative AI model.

The server, in one embodiment, generates a prompt sentence such as:

“You are a travel assistant. The current time is 9:00 AM. The user is at an international airport terminal, arrival lobby. The user's flight departs at 10:30 AM from Gate 25. The user wants to arrive at the gate by 10:00 AM. The user prefers normal walking speed and wants 20 minutes for duty-free shopping. Please generate a step-by-step movement plan inside the airport with approximate time ranges for each step.”

In another embodiment, the server generates a prompt sentence such as:

“You are a travel planning assistant. The user is at a domestic airport terminal. The user's flight departs at 3:00 PM from Gate 110. The current time is 1:15 PM. The user must arrive at the gate by 2:30 PM, prefers short walking distances, and wants to avoid stairs. Please propose a detailed, numbered plan describing where the user should go and at what times, including specific waypoints inside the facility.”

The server transmits the generated prompt sentence to a generative AI model hosted on an external or internal computing resource. The generative AI model is implemented as a machine-learned neural network, such as a transformer-based language model, that has a plurality of layers of self-attention modules, feed-forward modules, and normalization modules. The model parameters include weight matrices and bias vectors learned by supervised or semi-supervised training using a large corpus of text and structured instruction-following examples. During training, the model uses an objective function such as cross-entropy loss between predicted tokens and ground-truth tokens. The model updates weights using a gradient-based optimization algorithm, such as a variant of stochastic gradient descent with adaptive learning rates, and optionally uses regularization methods such as dropout and weight decay. The model may use data augmentation techniques, such as paraphrasing and instruction rephrasing, to improve robustness.

The generative AI model internally processes the prompt sentence by tokenizing the input into subword tokens, embedding the tokens into high-dimensional vectors, applying multi-head attention to capture relationships among tokens, and generating output tokens representing natural language instructions or structured pseudo-code-like descriptions of movement plans. The model does not simply reproduce training examples but computes context-dependent attention distributions and hidden state vectors that represent relationships among the extracted features and temporal constraints. The model outputs, for example, a numbered list of steps specifying actions, time ranges, and facility-specific hints.

The server receives the model output as text and parses the text using a text-structure extraction module. The server identifies structural markers such as “Step 1,” “Step 2,” or bullet markers, and segments the text into individual steps. The server then converts each step into a structured data element containing fields such as step index, start time, end time, action type (walk, wait, pass security, shop), and location references. The server stores this structured movement plan in the data store and associates it with the user session.

The server acquires dynamic information related to mobile objects, such as vehicles or transportation resources, via an external communication interface. In one embodiment, the server calls an external transportation information interface using a secure protocol to obtain updated schedule information, delay status, gate changes, and other time-varying attributes.

The server merges this dynamic information with the movement plan by adjusting the estimated times and possibly regenerating parts of the plan if the dynamic information conflicts with the initial assumptions.

The server also uses indoor positioning and facility route data. The server stores graph-based data representing a facility, where nodes represent intersection points, doors, elevators, or gates, and edges represent walkable segments with attributes such as distance, floor level, and accessibility flags. The server receives position-related information from the terminal, including indoor coordinates obtained from a positioning unit using wireless signals or sensors. The server maps these coordinates to the closest graph node and calculates a route to a destination node using a pathfinding algorithm such as A* search or Dijkstra's algorithm. The algorithm uses cost functions that consider distance, estimated walking time, and constraints (for example, avoiding stairs or minimizing transfers). The server outputs a sequence of waypoints and associated instructions.

The server, in one embodiment, formats at least a portion of the movement plan and the facility route into stepwise action instructions. The server combines the structured movement plan from the generative AI model with the route waypoints to refine or verify timings and directions. The server generates a sequence of instructions that specify in temporal order the actions to be taken by the user, the approximate time interval for each action, and where applicable, map coordinates or facility identifiers. The server provides these instructions to the terminal in a structured format.

The terminal receives the instructions and renders them on the display. The terminal uses a graphical user interface framework of the operating system to draw text, icons, and map overlays. The terminal may show a map view with a polyline representing the route and text panels summarizing stepwise instructions. The terminal updates the displayed information based on subsequent updates from the server.

The terminal acquires position-related information from hardware sensors, such as a satellite positioning receiver, a wireless network interface, and motion sensors. The terminal uses a positioning software component that fuses signals using a filtering algorithm, such as an extended Kalman filter, to estimate the current position. The terminal periodically transmits position updates to the server, allowing the server to update the movement state of the user. If the server detects a deviation from the planned route exceeding a threshold distance or time, the server updates the prompt sentence and requests the generative AI model to generate a revised movement plan. This feedback loop enables adaptive guidance in response to real-world conditions.

The server maintains operation history information and response history information. The server records, in persistent storage, data regarding user selections, deviations, accepted recommendations, and ignored recommendations. The server also records properties of generated movement plans such as the number of steps, duration, and types of actions. The server uses this history to adjust prompt generation and presentation format. For example, if the history indicates that a user frequently ignores optional shopping steps, the server shortens or omits such steps in future prompt sentences by modifying template parameters before sending them to the generative AI model. This adaptation is implemented as a machine-executed adjustment algorithm that modifies feature weights or includes additional contextual phrases in prompt sentences, not merely as static user preferences.

This configuration provides a technical improvement over conventional systems in several respects. The server centralizes the creation and refinement of prompt sentences and movement plans, thereby reducing the complexity of the terminal application and minimizing redundant logic on multiple client devices. The server uses structured data representations and specific algorithms for feature extraction, template selection, pathfinding, and history-based adaptation, which improve the consistency and accuracy of guidance output. The use of a generative AI model is not a mere automation of human planning; instead, the system causes the model to operate with machine-optimized prompts that encode facility graph properties, timing constraints, and user behavior statistics, enabling the model to output plans that are directly convertible into efficient, machine-parsable instructions.

Because the server parses and structures the model's natural language output into specific data fields, the server can check and correct internal consistency, such as ensuring that summed step durations do not exceed the available time window. The server can automatically correct or regenerate subplans if inconsistencies are found. This two-layer architecture, combining neural generation with deterministic verification and path computation, reduces error rates and misguidance compared to systems that rely solely on static rule-based planners or unstructured natural language responses.

The server also reduces communication load by sending compact structured updates rather than full recomputed plans when only small deviations occur. For example, when the user deviates slightly but remains within a corridor of the planned route, the server transmits only updated waypoint indices and small timing adjustments instead of a full new plan. This selective update strategy is enabled by the structured representation of plans and routes, and leads to reduced network traffic and lower latency.

In another embodiment, the server executes different generative AI models for different tasks. The server may use a first generative AI model specialized in summarization to compress movement-related requests into a concise summary, and a second generative AI model specialized in step-planning to generate detailed stepwise instructions. The server selects which model to use based on the structure of the prompt sentence and the required output format. This modular model usage further improves computational efficiency because not all tasks require a large, general-purpose model.

In an alternative embodiment, the server hosts the generative AI model locally, rather than accessing an external service. In this case, the server deploys a pre-trained transformer-based model on dedicated hardware accelerators, such as graphics processing units or tensor processing units. The server loads the model weights into device memory and performs inference by executing a series of matrix multiplications and non-linear transformations in a streaming fashion. The server may quantize model weights to reduce memory usage and improve inference speed. The server may also use batched inference for multiple user sessions to amortize computational cost and further reduce latency.

The terminal, in another embodiment, can perform a subset of routing and formatting tasks locally to maintain limited functionality during temporary network disconnections. However, the core classification, prompt generation, generative AI integration, and history-based adaptation remain on the server, ensuring that the system's essential behavior and improvements to computer technology are concentrated in server-side processing.

The described embodiments show that the server does not merely implement a business method but performs specific data transformations and algorithmic procedures that improve processing speed, guidance accuracy, and resource utilization. The combination of structured prompt generation, neural sequence modeling, graph-based routing, and feedback from historical data refines data paths and reduces duplicated computation. This leads to technical effects such as reduced processing time for generating updated plans, reduced communication overhead between server and terminal, and improved reliability of arrival-time predictions in complex facilities.

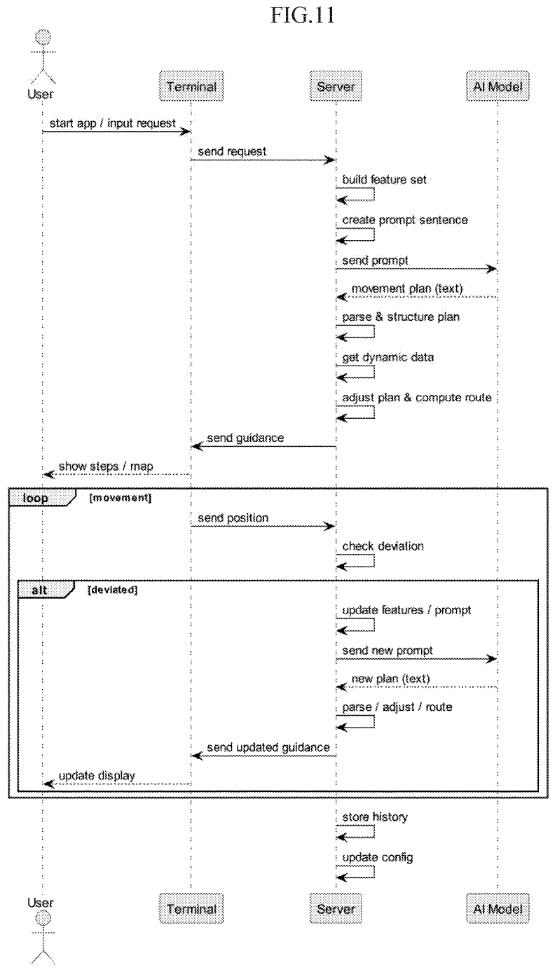

The following describes the processing flow using FIG. 11.

### Step 1:

The user starts an application on the terminal.

The terminal loads a main screen layout from local storage and initializes in-memory data structures for session state, including fields for current position, destination, movement preferences, and movement plan.

Input: user touch event on an application icon.

Output: an initialized application state in memory and a rendered main screen on the terminal display.

### Step 2:

The user inputs movement-related requests on the terminal.

The terminal displays input fields for current location, destination, desired arrival time, and preferences such as walking speed and avoidance of stairs, and receives corresponding touch and text input from the user.

Input: user text input, selection input, and current time obtained from the operating system.

Output: a structured request object containing position-related information and movement-related requests stored in the terminal memory.

### Step 3:

The terminal validates the movement-related requests.

The terminal checks the syntax and range of the input values, for example verifying that the destination is not empty, that the desired arrival time is later than the current time, and that option values match predefined enumerations. The terminal performs comparison and pattern-matching operations on the request object.

Input: the structured request object from Step 2.

Output: either an error message shown to the user when validation fails, or a validated request object ready for transmission when validation succeeds.

### Step 4:

The terminal transmits the validated request to the server.

The terminal serializes the validated request object into a data format, encapsulates it in a network message, and sends the message through a wireless communication module over a network to the server. The terminal starts an asynchronous communication process to wait for a response.

Input: the validated request object from Step 3.

Output: a network message containing the request, delivered to the server, and a pending response state in the terminal.

### Step 5:

The server receives and stores the position-related information and movement-related requests.

The server reads the incoming network message from the network interface, deserializes the data into internal data structures, and writes the position-related information and requests into a data store, including fields for user identifier, timestamps, coordinates, destination identifiers, and preferences.

Input: the network message from the terminal.

Output: stored records in a database or similar storage and an internal session object associated with the user.

### Step 6:

The server extracts features from the stored information.

The server reads the session object and computes normalized features such as facility identifier, origin node identifier in a facility graph, destination node identifier, available time interval, and preference flags. The server converts raw coordinates into facility-specific node identifiers by searching a spatial index and performs time-interval calculations by subtracting current time from desired arrival time.

Input: the stored records and session object from Step 5.

Output: a feature set object containing normalized variables for prompt generation and routing.

### Step 7:

The server selects a prompt template based on the feature set.

The server evaluates conditions on the feature set, such as whether the origin and destination are inside one facility, whether multiple transport modes are involved, and whether accessibility constraints are present. The server applies decision logic to choose one template identifier from a plurality of prompt templates stored in configuration data.

Input: the feature set object from Step 6.

Output: a selected prompt template and a mapping of template placeholders to feature fields.

### Step 8:

The server generates a prompt sentence for a generative AI model.

The server performs string-formatting operations on the selected prompt template, replacing placeholders with textual representations of feature values such as times, locations, and preferences. The server concatenates these segments into a coherent natural language instruction.

Input: the selected prompt template and the feature set object from Step 7.

Output: a prompt sentence expressed as a natural language text string ready to be sent to the generative AI model.

### Step 9:

The server transmits the prompt sentence to a generative AI model.

The server encapsulates the prompt sentence and model configuration parameters into a model-inference request, sends the request via a communication interface to a model execution environment, and waits for a response. The server identifies the model type and version in the request metadata.

Input: the prompt sentence from Step 8.

Output: a model-inference request transmitted to the generative AI model and a pending inference state at the server.

### Step 10:

The generative AI model generates a natural language movement plan.

The generative AI model converts the prompt sentence into tokens, computes embeddings, and applies a neural network architecture with multiple attention layers and feed-forward layers to produce output tokens. The model executes matrix multiplications, non-linear activations, and attention-weight calculations using model parameters previously learned during training.

Input: the prompt sentence contained in the model-inference request from Step 9.

Output: a generated natural language response text that includes stepwise descriptions of a movement plan.

### Step 11:

The server receives and parses the model output.

The server obtains the generated response text from the model execution environment, splits the text into individual lines, and identifies structural markers such as step numbers or bullet symbols using pattern matching. The server constructs an ordered list of step descriptions from these segments.

Input: the generated natural language response text from Step 10.

Output: an ordered list of raw step texts representing a candidate movement plan.

### Step 12:

The server converts the raw step texts into structured movement plan data.

The server applies text-processing rules and simple parsing algorithms to extract time ranges, action types, and location references from each step text. The server maps textual location expressions to node identifiers in a facility graph when possible. The server builds a structured movement plan containing records for each step with fields for index, start time, end time, action category, and associated node identifiers.

Input: the ordered list of raw step texts from Step 11.

Output: a structured movement plan object stored in server memory.

### Step 13:

The server acquires dynamic information related to mobile objects.

The server calls external information interfaces to obtain real-time schedule and status information for transportation resources such as flights or vehicles. The server receives structured records with updated departure times, delays, gate changes, and cancellations, and stores or updates corresponding records in its data store.

Input: identifiers of transportation resources derived from the feature set and the movement plan from Step 12.

Output: updated dynamic information records associated with the user's planned movement.

### Step 14:

The server adjusts the movement plan based on dynamic information.

The server compares the dynamic information with the timing and route assumptions in the structured movement plan. The server recalculates available time for each segment by updating time intervals and, if necessary, marks certain steps as invalid or requires regeneration. The server reorders or shortens steps to maintain compliance with the desired arrival time, using arithmetic operations on the step time fields.

Input: the structured movement plan from Step 12 and the dynamic information records from Step 13.

Output: an adjusted movement plan object that reflects current real-world conditions.

### Step 15:

The server computes an indoor route corresponding to the movement plan.

The server reads a facility graph from storage, identifies origin and destination nodes from the feature set and movement plan, and runs a path-search algorithm such as A* search on the graph. The server computes path costs based on distance, floor changes, and accessibility flags, and selects a minimum-cost path according to user preferences.

Input: origin and destination node identifiers from the feature set and movement plan from Step 14, and the facility graph.

Output: a sequence of waypoints representing a route within the facility.

### Step 16:

The server integrates the route with the movement plan.

The server associates specific steps in the movement plan with segments of the route by matching action categories (for example, walking or elevator use) and location identifiers.

The server inserts route waypoints and approximate distances into the step data structures, thereby enriching the plan with geometric information.

Input: the adjusted movement plan from Step 14 and the waypoint sequence from Step 15.

Output: a route-augmented movement plan that contains both temporal and spatial attributes for each step.

### Step 17:

The server formats stepwise action instructions for presentation.

The server converts the structured step data into concise text messages and optional metadata for graphical display. The server composes sentences that include time ranges, direction hints, and facility references, and orders them according to the step indices.

Input: the route-augmented movement plan from Step 16.

Output: a list of formatted stepwise action instructions ready for transmission to the terminal.

### Step 18:

The server transmits movement guidance information to the terminal.

The server packages the formatted stepwise action instructions and optional map-related data into a response message and sends the message over the network interface to the terminal.

The server marks the user session as having an active movement plan.

Input: the list of formatted stepwise action instructions from Step 17.

Output: a network response message delivered to the terminal containing movement guidance information.

### Step 19:

The terminal receives and displays the guidance information.

The terminal parses the response message, stores the stepwise action instructions in local memory, and updates user interface elements such as lists, panels, and map overlays. The terminal renders a sequence of steps and, if available, draws a route polyline on a facility map.

Input: the network response message from Step 18.

Output: a graphical and textual representation of guidance information visible on the terminal display.

### Step 20:

The terminal acquires updated position-related information during user movement.

The terminal reads raw measurements from positioning sensors, including satellite signals, wireless access point information, and motion sensor data. The terminal processes these measurements using a position-estimation algorithm to produce updated coordinates and, if available, indoor positions. The terminal periodically sends these positions to the server.

Input: sensor signals from the terminal hardware and timing information from the operating system.

Output: updated position-related information transmitted to the server and a local estimate of the user's current position.

### Step 21:

The server updates the movement state and checks for route deviation.

The server receives updated position-related information from the terminal, associates it with the corresponding user session, and compares the current position with the route-augmented movement plan. The server computes a distance metric between the current position and the planned route corridor and evaluates whether the metric exceeds a deviation threshold.

Input: updated position-related information from Step 20 and the route-augmented movement plan from Step 16.

Output: either a determination that the user remains on route or a determination that significant route deviation has occurred.

### Step 22:

The server regenerates or adjusts the movement plan when deviation is detected.

The server, upon detecting deviation beyond the threshold, recomputes relevant parts of the feature set and optionally generates a revised prompt sentence, then repeats Steps 8 through 16 for a shorter planning horizon. The server uses the new current position as the origin, updates remaining available time, and generates a new or partially updated movement plan and route.

Input: deviation determination from Step 21 and current feature set and movement plan.

Output: an updated movement plan and guidance instructions reflecting the new situation.

### Step 23:

The server sends updated guidance to the terminal.

The server encodes only changed steps or segments, if possible, to reduce data volume, and transmits revised instructions and route adjustments to the terminal. The server marks obsolete steps and updates the session state accordingly.

Input: the updated movement plan from Step 22.

Output: a network message containing updated guidance information delivered to the terminal.

### Step 24:

The terminal updates the displayed guidance based on the new information.

The terminal merges the updated guidance with previously displayed information, removes or marks obsolete steps, and emphasizes new or changed instructions. The terminal re-renders the route and step list on the display.

Input: the updated guidance message from Step 23.

Output: an updated display showing revised stepwise instructions and route visualization.

### Step 25:

The server records operation history information and response history information.

The server logs which guidance messages were sent, which movement plans were generated, how often route deviations occurred, and which options were selected by the user. The server stores these logs as structured records for later analysis and adaptation.

Input: session state changes, sent guidance data, and received position updates from previous steps.

Output: persisted history records representing operation history information and response history information.

### Step 26:

The server adjusts future prompt generation and presentation formats based on history.

The server analyzes stored history using statistical computations, such as frequency counts and time interval distributions, to detect patterns in user behavior. The server updates parameters used in template selection, feature weighting, and formatting rules for future prompt sentences and guidance messages.

Input: operation history information and response history information from Step 25.

Output: updated configuration parameters and modified behavior of future prompt generation and movement plan formatting, leading to improved guidance in subsequent sessions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional route guidance systems and mobility support systems typically compute routes by applying fixed optimization algorithms to map data and limited traffic information. Such systems generally provide a single “shortest” or “fastest” route and may present basic alerts about congestion or weather. However, these systems suffer from several technical limitations in terms of information processing and human-machine interaction. First, conventional systems do not flexibly integrate heterogeneous, real-time environment data such as detailed traffic conditions and localized weather phenomena into a unified optimization process that can adapt to different user roles and constraints. The systems often treat traffic and weather as simple add-on parameters, which results in suboptimal route calculation when conditions change dynamically, particularly for time-sensitive or safety-sensitive users such as couriers.

Second, existing systems provide limited explanation capability. They generally deliver numerical indicators such as estimated time of arrival and distance but do not generate rich, context-aware explanations that relate environment conditions to route choices. As a result, users cannot easily understand why a particular route is recommended, which reduces trust and makes it difficult for users to make informed decisions when multiple candidate routes exist.

Third, when real-time conditions change, such as when a new traffic jam or severe weather is detected, conventional systems may recompute a route but do not maintain a coherent reasoning history or adapt their behavior based on a user's past selections. They typically lack a mechanism to record and analyze user route preferences across time and to tune the route optimization and explanation generation accordingly.

Fourth, while generative AI models can generate natural-language text from prompts, there is no standardized, technical framework in conventional systems for systematically combining algorithmically optimized route data, real-time environment data, and user attributes into prompt sentences. Without such a framework, the interaction between deterministic routing algorithms and generative AI components remains ad hoc, which can lead to inconsistent or unreliable explanations, and to increased processing overhead due to poorly structured prompts.

Accordingly, there is a need for a computer-implemented system that (i) acquires and fuses real-time traffic and weather information from external information sources, (ii) calculates optimized route information that is dynamically weighted according to congestion and weather, (iii) generates prompt sentences for a generative AI model in a structured and adaptive manner based on route data, environment data, user attributes, and user constraints, (iv) obtains explanation information and evaluation information from the generative AI model to enrich the route guidance, (v) monitors environment changes and automatically regenerates routes and explanations when thresholds are exceeded, and (vi) records user-specific route choices to adjust algorithmic weighting and prompt generation conditions over time. By improving how the processor structures, optimizes, and explains route information using generative AI, the invention aims to enhance the technical performance of route computation, update handling, and user interaction in mobility support systems.

The specific processing by the specific processing unit 290 of the data processing device 12 in Application Example 1 is realized by the following means.

The present invention provides a server comprising a processor configured to receive position information and movement request information transmitted from a user information processing device; acquire environment information including traffic information and weather information from an external information providing device based on the received position information and movement request information; generate route candidate information representing a movement route based on the acquired environment information and the movement request information, and calculate optimized route information by performing weighting for each road section in accordance with a congestion level and a weather condition; generate a prompt sentence for input to a generative AI model on the basis of the optimized route information, a situation description information item summarizing the environment information, user attribute information, and constraint condition information; transmit the prompt sentence to the generative AI model and obtain movement plan description information including evaluation information and explanation information for the optimized route information from the generative AI model; generate movement plan information by associating the movement plan description information with the optimized route information, and transmit the movement plan information to the user information processing device; receive selection information or change request information for a plurality of presented movement plan information items from the user information processing device, and reflect the selection information or the change request information as the constraint condition information in regeneration of the prompt sentence and regeneration of the optimized route information; monitor a change of the environment information, and when a change in a traffic situation or a weather situation exceeding a predetermined threshold is detected, recalculate the optimized route information and generate an update prompt sentence including content representing the change, input the update prompt sentence to the generative AI model, obtain updated movement plan description information, and notify the updated movement plan description information to the user information processing device; and record the optimized route information and the movement plan description information for each user and each time, estimate a route preference of the user on the basis of the record, and adjust weighting parameters used in the calculation of the optimized route information and generation conditions used in the generation of the prompt sentence. This enables the server to technically improve route computation and explanation by tightly coupling deterministic optimization with generative AI processing, thereby providing dynamically updated, user-adaptive movement plans that integrate real-time environment data, and enhancing the efficiency, consistency, and intelligibility of computer-based route guidance.

The term “user information processing device” refers to an electronic device operated by a user, such as a mobile communication device, a portable terminal, or a general-purpose computing device, that is configured to transmit position information and movement request information to a server and to receive movement plan information from the server.

The term “position information” refers to data representing a geographic location of the user information processing device, including at least one of absolute coordinates, relative coordinates, or location identifiers, and optionally including time information associated with the location.

The term “movement request information” refers to information indicating a user's movement-related requirement, including at least one of an origin, a destination, a desired arrival time, a user role, or user-defined constraints such as route preferences.

The term “environment information” refers to information representing external conditions relevant to movement, including at least traffic information and weather information, and optionally including other real-time status data obtained from an external information providing device.

The term “traffic information” refers to data describing a state of a transportation network, including at least one of congestion levels, incident information, travel speeds, travel times, or road closures for road segments or other pathways.

The term “weather information” refers to data describing meteorological conditions, including at least one of precipitation, temperature, wind, visibility, or weather alerts for geographic regions relevant to a movement route.

The term “external information providing device” refers to a remote computing resource, such as an external server or service, that provides environment information including traffic information and weather information via a communication network.

The term “route candidate information” refers to data representing one or more possible movement routes between at least one origin and at least one destination, including at least route geometry and associated segment information before optimization.

The term “optimized route information” refers to route information that has been computed by applying an optimization process to route candidate information, including performing weighting on road segments in accordance with at least congestion levels and weather conditions to minimize or otherwise optimize a cost function.

The term “road section” refers to a unit segment of a transportation network, such as a portion of a road, path, or lane, for which traffic information, weather information, and associated weights may be individually determined.

The term “congestion level” refers to an indicator of traffic density or delay on a road section, described by at least one of a categorical level, a numerical index, or an estimated delay time.

The term “weather condition” refers to meteorological attributes applicable to a geographic area or road section, including at least one of precipitation intensity, visibility level, wind speed, or temperature range.

The term “situation description information” refers to information that summarizes environment information and optionally movement-related context in a form suitable for inclusion in a prompt sentence, including key traffic events, weather events, and temporal information.

The term “user attribute information” refers to information describing characteristics of a user or a category of users, including at least one of user role, typical behavior pattern, or preference profile.

The term “constraint condition information” refers to information specifying limitations or requirements for route computation or movement planning, including at least one of maximum travel time, route types to avoid, safety preferences, or timing constraints derived from user input or system policies.

The term “prompt sentence” refers to a data structure in natural-language or structured text form generated by the processor, which encodes optimized route information, environment information, user attribute information, and constraint condition information, and is provided as input to a generative AI model to request generation of movement plan description information.

The term “generative AI model” refers to a machine learning model, such as a large language model, that is configured to generate text or structured output in response to a prompt sentence, including evaluation information and explanation information for optimized route information.

The term “movement plan description information” refers to information generated by the generative AI model based on a prompt sentence, including at least evaluation information and explanation information describing recommended routes, alternative routes, and their characteristics.

The term “evaluation information” refers to information indicating an assessment of one or more routes, including at least one of a ranking, a recommendation, or comparative metrics among candidate routes.

The term “explanation information” refers to natural-language or structured text that describes reasons for recommending or not recommending particular routes, including references to traffic conditions, weather conditions, constraints, or user attributes.

The term “movement plan information” refers to data produced by associating movement plan description information with optimized route information, suitable for presentation to a user for guidance and selection.

The term “selection information” refers to information transmitted from the user information processing device that indicates a user's choice among multiple movement plan information items or multiple routes.

The term “change request information” refers to information transmitted from the user information processing device that indicates a user's request to modify constraint condition information or other parameters affecting movement planning.

The term “update prompt sentence” refers to a prompt sentence generated after detection of a significant change in environment information, the prompt sentence including content representing the detected change and being used to obtain updated movement plan description information from the generative AI model.

The term “updated movement plan description information” refers to movement plan description information generated by the generative AI model in response to an update prompt sentence that reflects changed environment conditions.

The term “predetermined threshold” refers to a condition or value defined by the system, such as a minimum change in estimated travel time, congestion level, or weather severity, that is used to determine whether an environment change is significant enough to trigger recalculation and regeneration.

The term “route preference” refers to a tendency or pattern inferred for a user, based on historical selection information and movement plan information, indicating favored route characteristics such as faster arrival, fewer transfers, or safer conditions.

The term “weighting parameters” refers to numerical or categorical values used by the processor to assign weights to road sections or route attributes during calculation of optimized route information.

The term “generation conditions” refers to parameters and rules that control how the processor constructs prompt sentences, including which fields of optimized route information, environment information, user attribute information, and constraint condition information are included and how they are formatted.

In one embodiment, a server, a plurality of terminals, and a network constitute a movement support system that implements the claimed functions. The server includes at least one processor, a main memory, a nonvolatile storage device, and a network interface. The terminal includes an application processor, a memory, a location sensor, a display device, and a communication interface. The user operates the terminal to request movement guidance and to receive movement plan information.

The server executes an operating system such as a server-grade OS and a middleware stack including a web server component and an application framework. The server stores program modules in the nonvolatile storage device. The program modules include a data acquisition module, a route optimization module, a prompt generation module, a generative AI interface module, a preference learning module, and a communication control module. The server loads these modules into the main memory and executes them by the processor.

The terminal executes a mobile operating system, for example, a smartphone OS, and runs a movement support application implemented with a cross-platform user interface framework such as a component-based UI framework. The terminal uses a location API provided by the OS to access a GPS sensor and other positioning resources. The terminal uses a network library to communicate with the server via a packet-switched network.

The server acquires environment information by using the data acquisition module. The server sends HTTP requests to external information providing devices that offer traffic information and weather information. The external information providing devices return responses in a structured data format such as JSON. The server parses each JSON response into an internal data structure stored in the main memory. The internal data structure is implemented as a graph-based representation in which a transportation network is modeled as nodes corresponding to intersections or waypoints and edges corresponding to road sections. Each edge is associated with attributes including base travel time, distance, congestion level, weather conditions, and reliability scores.

The server stores the environment information in a time-indexed data store. For example, the server assigns a timestamp and a region identifier to each environment information record.

The server maintains an in-memory cache of recent environment data in a key-value store keyed by a combination of road section identifier and time window. This data structure allows the server to quickly access the latest congestion level and weather condition for each road section during route optimization, reducing the need to query external services repeatedly and thereby decreasing communication load and response latency.

The server performs route optimization by using the route optimization module. The route optimization module implements a weighted shortest-path algorithm over the graph-based representation of the transportation network. The server assigns a weight to each road section based on a cost function that combines at least the base travel time, a congestion penalty, and a weather risk penalty. The congestion penalty is derived from traffic information such as current speed and expected delay. The weather risk penalty is derived from weather information such as precipitation intensity and visibility. The server can further adjust the cost function based on user attribute information and constraint condition information, for example, assigning a higher weight to safety-related penalties for a user who prefers safer routes, or assigning a higher weight to time for a courier with a strict delivery deadline.

The server implements the weighted shortest-path algorithm using a variant of Dijkstra's algorithm or A* search. The server uses a priority queue stored in memory to select the next road section to expand. For each candidate route, the server computes accumulated cost values and stores predecessor pointers to reconstruct the final route path. The server can calculate multiple candidate routes by applying different cost function parameters or by enforcing diversity constraints that avoid overlapping road sections. The server outputs optimized route information as a list of road section identifiers, associated coordinates, cumulative travel time, cumulative risk score, and other metadata.

The server generates a situation description information item by summarizing the environment information along each optimized route. The server selects prominent traffic events and weather events by applying a threshold-based filter to congestion levels and weather severity. For example, the server identifies any road section whose congestion level exceeds a congestion threshold or whose weather condition indicates heavy precipitation or low visibility. The server converts these events into textual phrases that can be concatenated into a human-readable summary. The server stores this summary as a situation description information item associated with each optimized route.

The server generates a prompt sentence by using the prompt generation module. The prompt generation module receives as input the optimized route information, the situation description information, the user attribute information, and the constraint condition information. The server constructs a template-based representation which includes fixed directive segments and variable segments filled with data fields. The prompt generation module formats numerical values such as distance and estimated time of arrival into textual descriptions according to predefined rules. The server can add explicit instructions specifying the desired structure of the output from the generative AI model, such as requiring route ranking, advantages and disadvantages, and safety considerations.

For example, the server can generate the following prompt sentence for a courier: “You are assisting a delivery courier. Current time is 16:30. The origin is the current user location and the destination is the customer address. Route A is 25 kilometers and estimated 45 minutes, with heavy congestion and heavy rain on a main highway. Route B is 30 kilometers and estimated 50 minutes, with moderate traffic and light rain on secondary roads. Based on these conditions, recommend the better route for on-time and safe delivery, explain your reasoning, and provide an estimated arrival time and any safety tips.”

As another example, the server can generate the following prompt sentence for a commuter: “The user is commuting to work and prefers to avoid highways and heavy rain. The current location is the user's home and the destination is the office. Current traffic shows minor congestion on city streets, and heavy rain is expected to start in about 30 minutes. Suggest two or three commuting routes and describe the pros and cons of each route in simple terms, including expected arrival time and exposure to rain.”

The server transmits the prompt sentence to a generative AI model by using the generative AI interface module. In one implementation, the generative AI model is a transformer-based neural network. The generative AI model includes an embedding layer, a plurality of self-attention layers, feed-forward layers, and a final output layer that produces tokens representing words or subwords. The generative AI model is trained on large corpora of text using a language modeling objective. The training process uses gradient-based optimization with a loss function defined as cross-entropy between predicted tokens and ground truth tokens. The weights of the network are updated by using an optimization algorithm such as stochastic gradient descent with adaptive learning rate. During inference, the server sends the prompt sentence to the generative AI model and receives output tokens which are decoded into natural-language text.

The server configures the generative AI model to produce movement plan description information in a constrained format. The server may include, in the prompt sentence, explicit markers indicating where route summaries, rankings, and explanations should appear. This structuring allows the server to reliably parse the generated text into structured fields after reception. The server uses parsing rules based on pattern matching and section headers to segment the output into evaluation information and explanation information for each route.

The server associates the movement plan description information with the optimized route information, thereby generating movement plan information. The server stores the movement plan information in memory and transmits it via the communication control module to the terminal. The server uses a compact serialization format to reduce communication size. For example, instead of transmitting full geometry for each update, the server can transmit only incremental changes or references to previously transmitted segments. This reduces bandwidth usage and improves responsiveness when frequent updates are necessary due to rapidly changing traffic or weather conditions.

The terminal receives the movement plan information and presents it to the user. The terminal decodes the optimized route information into a set of map coordinates and displays these coordinates on the display device as a polyline overlaid on a map image. The terminal renders the movement plan description information as text below the map. The user can visually inspect the route and read the explanation describing why the route is recommended, what alternative routes exist, and how traffic and weather affect the choice.

The user interacts with the terminal by touch input or other input methods. The user can select one of multiple routes displayed on the screen, or can modify constraints such as “avoid toll roads” or “prefer safer routes.” The terminal sends selection information or change request information back to the server. The server receives this information and updates the constraint condition information associated with the user. The server can immediately recompute optimized route information and regenerate a prompt sentence reflecting the new constraints. This closed-loop interaction allows the system to adapt to user preferences in real time.

The server monitors environment information and detects changes exceeding a predetermined threshold. For example, the server periodically polls the external information providing devices for new traffic and weather updates. The server compares updated congestion levels and weather conditions with previously stored values. When the server detects that the delay on a critical road section has increased beyond a delay threshold, or that a new severe weather alert has been issued for a region on the route, the server flags that route as degraded.

The server recalculates optimized route information by re-running the weighted shortest-path algorithm on the updated graph. The server then generates an update prompt sentence that describes the previously recommended route, the newly detected changes, and possible alternative routes.

For example, the server can generate an update prompt sentence as follows:

“The previously recommended route for a courier from the current location to the delivery address is now affected by a new traffic accident and heavy rain on a key segment. The original estimated time of arrival was 45 minutes, but the new delay adds about 20 minutes. A new alternative route is available with an estimated travel time of 55 minutes and lower weather risk. Explain why the courier should switch to the new route and summarize the main differences between the old and new routes.”

The server sends this update prompt sentence to the generative AI model, obtains updated movement plan description information, and transmits the updated movement plan information to the terminal. The terminal notifies the user that an updated route is available, displays both the old and new routes, and presents the new explanation. The user can then decide to accept or reject the updated route.

The server records optimized route information and movement plan description information for each user and each time. The server stores this information in a database as historical records. The records include, for example, user identifier, timestamp, origin, destination, selected route identifier, and key features of the route such as total travel time, number of transfers, and risk score. The server uses the preference learning module to analyze these records. The server can apply a statistical model or a machine learning model to infer route preference parameters for each user. For example, the server can estimate how strongly a user prefers shorter time versus lower risk by analyzing choices between competing routes with different trade-offs.

The server updates weighting parameters used in the cost function for route optimization based on the inferred preference parameters. The server also updates generation conditions used in the generation of prompt sentences, such as which aspects of the route and environment to emphasize in the explanation. This adaptive mechanism allows the server to improve technical performance over time by reducing the number of route recalculations that the user rejects and by converging on route suggestions that better match user-specific preferences.

This system provides several technical effects beyond mere automation of human decision-making. By modeling the transportation network as a weighted graph and continuously updating weights with real-time traffic and weather data, the server improves the precision and timeliness of route computation. The use of an in-memory cache and efficient shortest-path algorithms reduces computation time and network access, enhancing processing speed and reducing latency. The structured integration of optimized route information and situation description information into prompt sentences results in more consistent and machine-parseable outputs from the generative AI model, which improves the accuracy and reliability of downstream parsing and display.

Moreover, the server uses the generative AI model in a technically constrained manner: the model is driven by a carefully constructed prompt sentence that encodes structured route data, environment data, and user attributes. The server does not simply replace human reasoning with generic AI processing, but instead couples a deterministic optimization pipeline with a neural text generation module that operates under explicit constraints. This architecture allows the server to generate explanations that are tightly aligned with the internal route computations, thereby improving user understanding without sacrificing computational consistency.

The generative AI model is implemented as a multi-layer transformer neural network trained with specialized fine-tuning data that emphasizes explanations of mobility decisions. The server can fine-tune the model on domain-specific training data consisting of pairs of environment contexts and human-authored route explanations. The training process minimizes a loss function that penalizes divergence between generated explanations and reference explanations, and the server can incorporate additional regularization terms encouraging concise and structured outputs. As a result, the explanations produced during operation are tailored for mobility guidance and are more informative than generic text, contributing to improved user trust and reduced need for manual verification.

From a data management perspective, the server reduces communication load by transmitting incremental updates, by caching environment information, and by reusing precomputed partial routes when only a subset of road sections is affected by new conditions. The server can, for example, avoid recomputing entire routes when only a local detour is needed. This design improves scalability when many users request guidance simultaneously.

In alternative embodiments, the server can adjust the architecture of the generative AI model or the route optimization algorithm. For example, instead of a classical shortest-path algorithm, the server can use a reinforcement learning-based route selection mechanism that evaluates state-action pairs and value functions over the graph. The server can still generate prompt sentences based on the learned value estimates and can still obtain movement plan description information from the generative AI model. In another embodiment, the server can deploy a smaller, on-device generative model in the terminal for local explanation generation while the main optimization computation remains on the server.

In another variation, the terminal can implement additional user interface features, such as highlighting high-risk segments in a distinct color or providing auditory alerts when approaching segments with severe weather. The terminal can convert movement plan description information into speech via a text-to-speech engine, thereby supporting hands-free operation for drivers. These features further link the computation performed by the server to physical behavior in the real world by influencing actual movement paths and timing.

By combining these elements, the server, the terminal, and the user cooperate to realize a movement support system that not only calculates optimized routes but also provides adaptive, intelligible explanations grounded in real-time environment data and user behavior. The system improves computer technology by introducing specialized data structures, optimization algorithms, and neural text-generation methods that together enhance processing speed, route accuracy, communication efficiency, and explanatory quality in comparison with conventional systems that merely present static routes or simple traffic overlays.

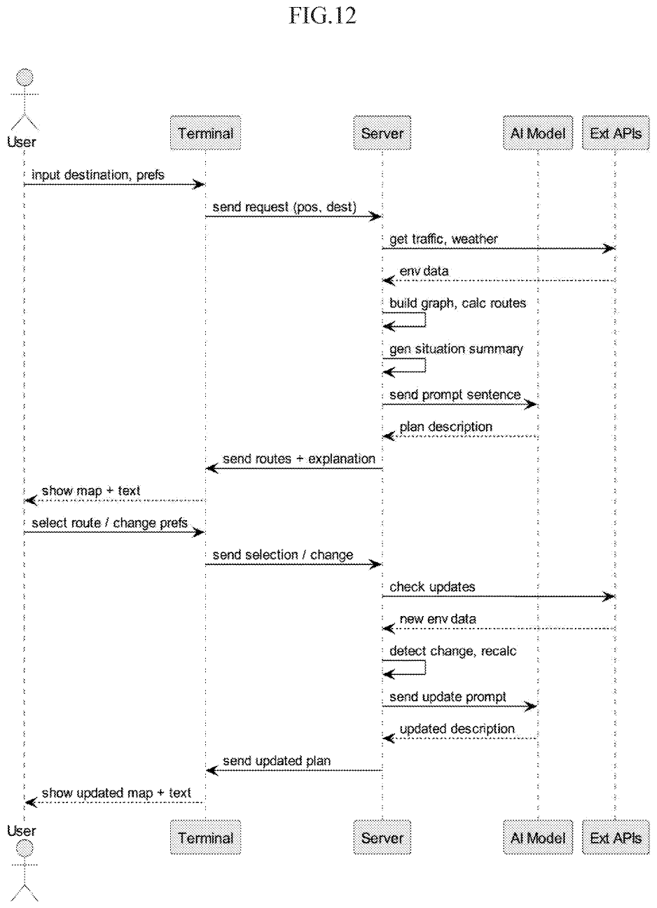

The following describes the processing flow using FIG. 12.

### Step 1:

The terminal acquires user context and transmits a movement request.

The terminal uses a location API to obtain position information (input: GPS signals and network-based location data; output: current latitude, longitude, optional speed, and timestamp). The terminal then displays a user interface screen where the user enters a destination, selects a user role (for example, courier or commuter), and specifies constraints such as “avoid highways” or “arrive before 18:00” (input: user touch operations; output: movement request information including destination, role, and constraints). The terminal combines the position information and the movement request information into a structured message and sends it to the server over a network connection (input: position information and movement request information; output: a network packet with a JSON payload containing these fields).

### Step 2:

The server receives and validates the movement request.

The server accepts the network packet from the terminal and parses the JSON payload (input: JSON-formatted position and request data; output: internal objects representing position information, movement request information, and user identifier). The server validates that coordinates are in a valid range, that a destination is present, and that constraint values match allowed formats (input: parsed fields; output: a validated request record or an error status). When the data is valid, the server writes the request record to a database with a timestamp (input: validated request object; output: a persistent record containing user ID, origin, destination, constraints, and time).

### Step 3:

The server acquires real-time environment information from external sources.

The server generates queries for external information providing devices that supply traffic and weather data (input: current origin/destination coordinates and time; output: HTTP request messages for traffic and weather services). The server sends these requests and receives structured responses (input: HTTP responses encoded as JSON; output: raw traffic information and raw weather information). The server parses the traffic JSON into a graph-oriented structure, assigning congestion levels and estimated delays to road sections (input: raw traffic JSON; output: a list of road sections with base travel time, congestion level, and distance). The server parses the weather JSON into a spatial index of weather conditions, associating weather attributes with geographic regions that overlap road sections (input: raw weather JSON; output: a mapping from region identifiers or coordinates to weather conditions such as precipitation and visibility).

### Step 4:

The server constructs a weighted road network and computes route candidates.

The server merges traffic information and weather information into a single graph representation (input: parsed road sections and weather mapping; output: a weighted graph where each edge represents a road section with attributes for base travel time, congestion level, and weather condition). The server defines a cost function, for example: cost=base_travel_time+congestion_penalty+weather_risk_penalty, where each term is computed from the attributes and may be scaled according to user constraints and user attributes (input: edge attributes and user preferences; output: per-edge weight values). The server runs a shortest-path algorithm such as Dijkstra or A* over the weighted graph to compute one or more route candidates between the origin and destination (input: weighted graph, origin node, destination node; output: route candidate information as ordered lists of road sections with cumulative cost and travel time).

### Step 5:

The server calculates optimized route information.

The server ranks the route candidates by their cost values and evaluates their characteristics, such as total distance, total time, and total weather risk (input: route candidate information with per-route cost metrics; output: a sorted list of route candidates). The server selects at least one optimal route and optionally several alternative routes according to system-defined rules (for example, the lowest-cost route and one or two diverse alternatives) (input: sorted route list; output: optimized route information including selected route paths and associated metrics). The server converts each route path into a form suitable for transmission, such as a sequence of coordinates or compressed polylines (input: internal graph-based paths; output: route geometry data bound to each optimized route).

### Step 6:

The server generates situation description information for each optimized route.

The server examines each road section in an optimized route to detect notable events, such as congestion levels exceeding a threshold or weather conditions indicating heavy precipitation (input: optimized route information, environment information; output: a filtered list of significant events associated with each route). The server composes textual phrases describing these events, such as “heavy congestion on a main highway segment” or “heavy rain expected near the destination” (input: event list; output: natural-language fragments for each event). The server aggregates these fragments into a coherent summary per route, forming situation description information (input: text fragments; output: per-route summaries describing traffic and weather conditions along the path).

### Step 7:

The server generates a prompt sentence for a generative AI model.

The server retrieves user attribute information (for example, role and historical preference parameters) and constraint condition information related to the current request (input: database records and request constraints; output: user attribute object and constraint object).

The server then builds a prompt template specifying sections for context, route summaries, user constraints, and output requirements (input: template definition; output: an intermediate structured representation). The server fills the template with actual values from the optimized route information and situation description information, formatting numerical values into readable text (input: optimized route information, situation description information, user attributes, constraints; output: a complete prompt sentence). For example, the server can output a prompt sentence such as: “You are assisting a delivery courier. Current time is 16:30. Route A is 25 kilometers and estimated 45 minutes, with heavy congestion and heavy rain on a main highway. Route B is 30 kilometers and estimated 50 minutes, with moderate traffic and light rain. Recommend the better route and explain your reasoning, including arrival time and safety tips.”

### Step 8:

The server requests explanation and evaluation from the generative AI model.

The server transmits the prompt sentence to a generative AI model via an AI interface (input: prompt sentence text and model parameters such as temperature and maximum tokens; output: a model inference request). The generative AI model processes the prompt sentence and returns generated tokens that the server decodes into natural-language text (input: model output tokens; output: movement plan description information as coherent text). The server receives the text and segments it into distinct parts, such as identification of a recommended route, descriptions of alternatives, and explanation of advantages and disadvantages (input: generated text; output: structured movement plan description information including evaluation information and explanation information linked to each route).

### Step 9:

The server associates explanations with routes and generates movement plan information.

The server links each portion of the movement plan description information to the corresponding optimized route using route identifiers included in the prompt sentence (input: structured movement plan description information and optimized route information; output: combined objects where each route has associated explanation and evaluation fields). The server creates movement plan information that contains route geometry, estimated arrival times, and textual explanation for each route (input: combined route-explanation objects; output: a response payload containing one or more movement plan information items ready for transmission). The server may compress geometry data and remove redundant fields to reduce payload size (input: full movement plan information; output: optimized, size-reduced data structures).

### Step 10:

The server transmits movement plan information to the terminal.

The server packages the movement plan information in a structured message and sends it to the terminal through a secure network channel (input: movement plan information; output: a network packet containing route data and associated explanations). The server also records the transmitted movement plan information in a database for later analysis (input: movement plan information; output: a historical log entry mapping user ID, proposed routes, and time).

### Step 11:

The terminal presents routes and explanations to the user.

The terminal receives the message containing movement plan information and parses the structured data (input: response payload; output: internal objects representing optimized routes and associated explanations). The terminal uses the route geometry data to draw paths on a map displayed on the screen and places markers for origin and destination (input: route coordinates; output: rendered polylines and markers on the display). The terminal also shows the movement plan description information as text adjacent to the map, highlighting the recommended route and any notable traffic or weather conditions (input: explanation text; output: a user interface that combines visual route guidance and textual explanation).

### Step 12:

The user selects a route or modifies movement constraints.

The user inspects the displayed map and explanation text and then interacts with the terminal to choose one of the proposed routes or to adjust preferences (input: visual and textual information on the display; output: user decisions expressed as touch or other input events).

The user may tap on an alternative route or open a settings panel to enable options such as “avoid toll roads” or “prefer safer routes even if slower.” The terminal interprets these interactions and converts them into selection information or change request information (input: low-level input events; output: structured selection or constraint change messages).

### Step 13:

The terminal sends selection or change information to the server.

The terminal creates a message containing the chosen route identifier and any updated constraint condition information (input: selected route ID and new constraints; output: a JSON object or similar structured data). The terminal transmits this message to the server via the communication interface (input: structured selection data; output: a network packet carrying selection information or change request information).

### Step 14:

The server updates constraints and optionally recomputes routes.

The server receives the selection or change request information and updates the stored constraint condition information for the current session and optionally for the user profile (input: selection information and change request information; output: an updated constraint object stored in memory and/or database). Based on the new constraints, the server may invoke the route optimization module again, reusing the existing environment information and weighted graph when possible (input: updated constraints and current environment information; output: updated optimized route information). When recomputing is necessary, the server follows the same processing as in Steps 4 and 5, but may only adjust relevant parts of the graph to improve computational efficiency.

### Step 15:

The server monitors environment changes and detects significant events.

The server periodically or event-driven acquires updated environment information from external information providing devices (input: timer events or triggers from previous updates; output: new traffic and weather JSON records). The server compares new congestion levels and weather conditions with previously stored values for the road sections included in active routes (input: new environment information and cached environment information; output: difference metrics such as additional delay or increased weather severity). The server determines whether any change exceeds a predetermined threshold (for example, more than 10 minutes additional delay or a change to severe weather) (input: difference metrics and threshold values; output: a binary decision and a list of affected road sections and routes).

### Step 16:

The server recalculates routes and generates an update prompt sentence when thresholds are exceeded.

When the server determines that changes are significant, the server recalculates optimized route information by invoking the route optimization module with updated weights on affected road sections (input: current graph with updated weights, origin, destination; output: new optimized route information and possibly new alternative routes). The server then composes an update prompt sentence that refers to the previously recommended route, the detected changes, and the newly available alternative route(s) (input: old route information, new route information, and change description; output: an update prompt sentence). For example, the server may generate a prompt sentence such as: “The previously recommended route is now delayed by 20 minutes due to an accident and heavy rain. A new alternative route is available with a 55-minute ETA and lower weather risk. Explain why the user should consider switching and summarize the trade-offs.”

### Step 17:

The server requests updated explanations from the generative AI model and notifies the terminal.

The server sends the update prompt sentence to the generative AI model and receives updated movement plan description information (input: update prompt sentence; output: updated evaluation and explanation text for old and new routes). The server merges this updated movement plan description information with the new optimized route information and generates updated movement plan information (input: new route data and updated explanations; output: a revised response payload). The server then transmits the updated movement plan information to the terminal and may additionally send a push-type notification indicating that an improved route is available (input: updated movement plan information; output: network messages to the terminal).

### Step 18:

The terminal presents updates and the user responds.

The terminal receives the updated movement plan information and notification, then updates the displayed map to show both the original route and the new recommended route (input: updated route geometry; output: revised visual routes on the display). The terminal replaces or augments the previous explanation text with the new explanation describing why a change is recommended (input: updated explanation text; output: refreshed textual information on the screen). The user compares the routes and may either accept the new route or continue with the old route by interacting with the terminal (input: updated UI; output: new selection information). The terminal sends this selection back to the server, which records the user's decision in the database (input: user's acceptance or rejection; output: log entries that will later be used for preference learning).

### Step 19:

The server learns user route preferences from historical data.

The server periodically analyzes historical records of proposed routes, selected routes, and associated features (input: stored movement plan information and selection logs; output: aggregated statistics per user). The server applies a model, such as a linear regression or a small neural network, to infer preference weights that quantify the importance of travel time, distance, and risk for each user (input: aggregated statistics; output: preference parameters per user). The server updates weighting parameters in the route optimization cost function and adjusts which aspects are emphasized in future prompt sentences (input: new preference parameters; output: updated cost function configuration and prompt generation rules). This adaptation improves the likelihood that future optimized route information and generated explanations will align with the user's actual preferences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented navigation and information provision systems that operate in large indoor environments, such as transportation facilities, generally rely on static routing logic and fixed rule-based templates for generating user guidance. These systems typically treat positioning, routing, external status information, and message generation as separate subsystems that are loosely integrated through simple data passing. As a result, several technical problems arise in terms of computer technology.

First, conventional systems often process position information using a single type of sensor data, for example, only satellite-based positioning signals or only short-range wireless signals. This leads to low robustness and low accuracy in complex indoor environments with signal reflections or occlusions, and causes frequent misalignment between the user's actual position and the route data represented in a spatial database. From a computing perspective, the routing engine operates on degraded or inconsistent input coordinates, which increases the need for repeated recalculation and error correction at the application layer, thereby consuming unnecessary processing resources and network bandwidth.

Second, traditional routing engines embedded in such systems typically employ a fixed cost function, such as shortest distance or minimal nominal time, without dynamically incorporating user-specific constraints and real-time external operation information. For example, delay information or gate reassignment information for moving bodies is often retrieved and displayed independently of the route search process. As a result, a processor must execute separate workflows for route computation and for external information presentation, and the system must perform additional synchronization logic between these workflows. This fragmented processing causes inefficiencies in both computation and memory usage, and increases latency for route updates when the external operational environment changes.

Third, many existing systems generate user-facing guidance messages using static templates or simple conditional branching based on route steps. These message generation mechanisms are not designed to consume rich, structured context, and therefore require developers to manually define large numbers of templates and conditional rules for different scenarios. When the system must adapt to various user conditions, such as limited remaining time, accessibility needs, or complex rerouting events, traditional template-based approaches require extensive branching logic and redundancy in code and data structures. This increases code complexity, reduces maintainability, and limits the ability of the computing system to flexibly adjust its behavior.

Fourth, conventional systems generally treat user inquiries and free-form requests as separate from the routing and planning logic. Free-form text questions, if supported at all, are handled by simplistic keyword matching or by passing the questions to external services without structured context. In these architectures, the computing platform does not systematically construct machine-readable context that combines current position, active route, movement plan, and external operation status. Consequently, the responses returned to users are often generic and disconnected from the system's internal state, forcing additional application-side integration logic and repeated network calls, which increases processing overhead and degrades responsiveness.

Fifth, traditional systems lack a unified mechanism for leveraging generative AI models as core computational components that operate directly on structured route and planning data. In many cases, generative models, if used, are attached as auxiliary components that simply rewrite or summarize text. Without joint optimization of structured data processing (such as route graphs and temporal constraints) and generative operations (such as natural language response generation), the computing platform cannot fully exploit the capability of modern models to perform context-sensitive reasoning. This leads to duplicated logic between routing code and message generation code, inconsistent decision criteria, and increased consumption of computing resources.

Accordingly, there is a need for improved computer-implemented techniques that (i) integrate multi-source positioning data into a coherent current position representation aligned with a spatial database, (ii) compute and update optimal routes using a dynamically adjustable evaluation function that incorporates user-specific constraints and external operation information, (iii) generate structured context objects that unify route data, time margins, and facility information, and (iv) use such structured context as the basis for systematically constructing prompt sentences for a generative AI model. There is also a need to process free-form user inquiries as structured prompts enriched with internal system state, and to feed model-generated responses back into the routing pipeline in a controlled manner. By solving these issues, the invention aims to improve the technical operation of computers that perform navigation, planning, and assistance in complex indoor environments, providing more accurate routing, reduced latency in recalculation, lower overall processing overhead, and enhanced flexibility in generating context-aware responses.

The specific processing by the specific processing unit 290 of the data processing device 12 in Example 2 is realized by the following means.

The present invention provides a server comprising a processor and one or more memory devices storing instructions that, when executed by the processor, cause the processor to receive position information and movement request information transmitted from a user terminal device, integrate a plurality of types of position data including positioning information from a positioning device and signal strength information from a short-range wireless signal generation device in order to identify a current position of a user in correspondence with route information stored in a spatial information storage device, execute route search processing on route structure information representing indoor passage sections, connection points, and elevation means by using an evaluation function that applies weights to distance information, required time information, congestion information, and usage condition information based on the movement request information and the current position so as to calculate optimal route information to a destination, acquire moving body operation information, boarding point information, delay information, and time information from an external information provision device and integrate the acquired information with the optimal route information to calculate movement margin time for the user and dynamically update the evaluation function in accordance with the movement margin time to generate movement plan information adapted to the user, generate structured data including route section information, movement distance information, required time information, facility information, and support information within a facility by using the optimal route information and the movement plan information and generate a prompt sentence that designates the structured data as a description target, input the prompt sentence and the structured data into a generative AI model to cause the generative AI model to generate natural language response information including guidance text, explanatory text, and support text to be presented to the user, transmit the natural language response information and the optimal route information to the user terminal device, receive, as a prompt sentence, a free-form inquiry text transmitted from the user terminal device, generate context information including the inquiry text, the current position, the optimal route information, and the movement plan information, input the context information into the generative AI model to cause the generative AI model to generate response information and route change guidance information according to a situation of the user, generate updated route information by associating recalculated route information, obtained by re-executing the route search processing based on contents of the response information output from the generative AI model, with the route change guidance information, transmit the updated route information to the user terminal device, and analyze state information and operation history information of the user and adjust contents of the prompt sentence input to the generative AI model and an expression style of the natural language response information output from the generative AI model in order to change contents of a provided service. This enables the computing platform to unify multi-source positioning, dynamic route optimization, external operation integration, and generative AI-based natural language processing in a single control loop, thereby improving accuracy and stability of route computation, reducing processing redundancy between routing logic and message generation logic, decreasing latency in route recalculation and guidance updating when environmental conditions change, and enhancing the system's capability to generate context-aware, user-specific assistance in real time.

The term “user terminal device” refers to an information processing device operated by a user, such as a portable communication device or a computing device, that is configured to acquire position information, transmit movement request information and inquiry text to a server, receive route information and natural language response information from the server, and present such information to the user via a user interface.

The term “position information” refers to data indicating a geographical or spatial position associated with a user or a user terminal device, including but not limited to coordinates, floor level, and time information, which are usable for associating the position with route information stored in a spatial information storage device.

The term “movement request information” refers to information indicating a request from a user regarding movement, including at least one of a destination, a preferred movement condition, a constraint, or a priority, which is used by a processor to determine an optimal route and movement plan.

The term “positioning device” refers to a hardware or software component that generates positioning information indicating a geographical or spatial position, including but not limited to satellite-based positioning units, inertial sensors, or other location-determination units.

The term “short-range wireless signal generation device” refers to a wireless communication device configured to emit signals detectable at a limited range, such as a beacon or other local wireless transmitter, whose signal strength information can be used to refine or correct position information of a user or user terminal device.

The term “signal strength information” refers to measurement data indicating a received power level or quality of a wireless signal from a short-range wireless signal generation device, which is used as part of the position data for determining a current position.

The term “spatial information storage device” refers to a storage component or storage system that stores spatial data, including route information, route structure information, and facility information, in a form that can be queried and processed by a processor for route calculation and guidance generation.

The term “route information” refers to data representing a path or set of paths within a facility or area, including nodes, links, distances, directions, and other attributes, used by a processor to guide a user from a current position to a destination.

The term “current position” refers to a position of a user or user terminal device determined at a given time by integrating a plurality of types of position data, including at least positioning information and signal strength information, in association with route information in a spatial information storage device.

The term “route structure information” refers to data that defines a topological structure of movement paths, including representation of indoor passage sections, connection points, and elevation means, and that is used by a routing algorithm to compute an optimal route.

The term “indoor passage sections” refers to logical or physical path segments within an indoor environment, such as corridors, walkways, or open areas, through which a user can move and which are represented as elements in the route structure information.

The term “connection points” refers to junctions, intersections, or nodes at which two or more indoor passage sections meet or connect, and which are used as graph nodes in route computation.

The term “elevation means” refers to movement facilities that change a user's vertical position, such as stairs, escalators, elevators, or ramps, which are represented as elements in the route structure information for route calculation.

The term “evaluation function” refers to a mathematical or algorithmic function that assigns a cost or score to a candidate route or route segment based on one or more parameters, including distance information, required time information, congestion information, and usage condition information, and that is used by a processor in route search processing to determine an optimal route.

The term “distance information” refers to data indicating a spatial separation or length of a path or path segment between two positions, used as one of the parameters in the evaluation function for route computation.

The term “required time information” refers to data indicating an estimated travel time for moving along a path or path segment, which may be based on distance, typical speed, facility type, or congestion, and is used in the evaluation function and in movement plan generation.

The term “congestion information” refers to data indicating a level of crowding, traffic density, or passage capacity on a route or within a facility, which may affect travel speed or travel time and is used by a processor to adjust route costs.

The term “usage condition information” refers to data indicating constraints or conditions related to the use of a path or facility, such as accessibility restrictions, operating hours, or permissible directions of movement, which are considered by a processor in the evaluation function.

The term “optimal route information” refers to route information selected or calculated by a processor as minimizing or otherwise optimizing a cost defined by an evaluation function, given a current position, a destination, and one or more constraints.

The term “moving body operation information” refers to information related to the operation status of a moving body, such as a vehicle or transport unit, including at least schedule data, operating status, and changes in operation that may affect user movement planning.

The term “boarding point information” refers to data indicating a location or area at which a user accesses or boards a moving body, such as a gate, platform, or stop, and which is relevant for route and movement plan calculation.

The term “delay information” refers to data indicating a deviation of a moving body's operation or schedule from an expected time, such as delay duration or new estimated departure or arrival times, and is used by a processor to adjust movement plans and evaluation functions.

The term “time information” refers to temporal data including current time, scheduled times, or time limits, which is used by a processor to calculate movement margin time and to adjust route planning.

The term “movement margin time” refers to a time margin calculated by a processor based on an optimal route, moving body operation information, and time information, indicating how much time a user has in excess of or relative to a reference time such as a departure or boarding time.

The term “movement plan information” refers to information generated by a processor that describes a user-specific movement scenario, including at least an optimal route, time allocations, and optional intermediate activities, adapted to the user's movement margin time and preferences.

The term “structured data” refers to data organized in a defined format, such as a set of records or objects, that includes route section information, movement distance information, required time information, facility information, and support information, and is suitable for programmatic processing and prompt generation.

The term “route section information” refers to data describing individual sections or segments of a route, including start and end points, type of section, length, and associated instructions, which are part of the structured data.

The term “movement distance information” refers to data indicating distances to be traveled along route sections or the entire route, expressed in suitable units and included within the structured data.

The term “facility information” refers to information about facilities located along or near a route, such as types, locations, attributes, and available services, which can be presented to a user as part of navigation or assistance.

The term “support information” refers to information related to assistance or help available to a user, including but not limited to support points, service counters, or guidance for dealing with problems, and is included in the structured data for use in response generation.

The term “prompt sentence” refers to a sentence or set of sentences generated or received by a processor and supplied to a generative AI model, which defines a description target, provides instructions or context, and guides the generative AI model in generating natural language response information.

The term “generative AI model” refers to a machine-learned computational model configured to generate natural language output based on given input, including at least prompt sentences and structured or contextual data, and capable of producing guidance text, explanatory text, and support text.

The term “natural language response information” refers to information output in a human language by a generative AI model, including guidance text, explanatory text, and support text, which is formatted for presentation to a user.

The term “guidance text” refers to a portion of natural language response information that provides instructions or directions to a user regarding movement or actions to be taken in relation to a route or facility.

The term “explanatory text” refers to a portion of natural language response information that provides explanations, clarifications, or additional contextual details related to a route, a facility, or a movement plan.

The term “support text” refers to a portion of natural language response information that provides assistance, troubleshooting steps, or recommendations to help a user deal with a problem or special situation.

The term “inquiry text” refers to free-form text representing a question, request, or statement received from a user via a user terminal device, which is used as at least part of a prompt sentence or context for a generative AI model.

The term “context information” refers to a collection of data including at least an inquiry text, a current position, optimal route information, and movement plan information, which is constructed by a processor and provided to a generative AI model to enable context-aware response generation.

The term “route change guidance information” refers to information generated based on output of a generative AI model that instructs or recommends a change to an existing route, including reasons, instructions, or conditions for the change.

The term “updated route information” refers to route information that has been recalculated or modified based on contents of response information and route change guidance information, and that replaces or augments prior optimal route information.

The term “state information” refers to information indicating a status of a user or a user terminal device, including but not limited to movement state, interaction state, or temporal state, which is used to adjust prompt sentences and response styles.

The term “operation history information” refers to information indicating past interactions or operations performed by a user via a user terminal device, such as previous routes, queries, selections, or confirmations, which is stored and analyzed to modify future system behavior.

The term “service category” refers to a classification of a service function provided by a system, such as navigation, information provision, or problem support, which can be specified as part of instruction information in a prompt sentence.

The term “guidance type” refers to a classification of a mode or style of guidance, such as step-by-step navigation, summary guidance, or detailed explanation, that may be indicated in instruction information and used to control the generative AI model output.

The term “support type” refers to a classification of a mode or style of support, such as emergency assistance, general help, or recommendation support, that may be indicated in instruction information and used in response generation.

The term “deviation determination processing” refers to processing executed by a processor to determine whether a current position deviates from or is inconsistent with optimal route information or whether a destination has changed, based on positional relationships between the current position and the route.

The term “external information provision device” refers to a device or system external to the server that provides operation-related information, such as moving body operation information, boarding point information, delay information, or time information, via a communication interface.

The term “user” refers to an individual or entity that utilizes the user terminal device and receives navigation, planning, or support services from the system.

The term “server” refers to a computing apparatus including at least one processor and memory, configured to execute instructions for receiving data from one or more user terminal devices, performing route and plan computation, interacting with a generative AI model, and transmitting response information back to the user terminal devices.

The server executes the invention as software running on one or more computing devices such as a rack-mounted computer, a virtual machine, or a container instance. The server includes at least one multi-core central processing unit, main memory, network interfaces, and non-volatile storage. The server runs a general-purpose operating system such as a UNIX-like operating system and executes middleware including a web application framework, a database management system, and a model inference engine. The server stores instructions in a non-transitory computer-readable medium, and those instructions implement the functions described below when executed by the processor.

The terminal executes a client program on a portable communication device such as a smartphone or a tablet computer. The terminal includes a central processing unit, a graphics processing unit, volatile memory, non-volatile storage, a touchscreen display, a satellite-based positioning module, a short-range wireless communication module such as a Bluetooth Low Energy module, and a network interface for connecting to a wireless local area network or a mobile communication network. The terminal executes an operating system such as a mobile operating system and runs an application that implements the client-side functions described below.

The user operates the terminal through a graphical user interface displayed on the touchscreen. The user allows the terminal to access positioning resources, selects destinations inside a facility, enters preferences, and submits free-form questions. The user views guidance information and graphical route representations provided by the terminal.

The server implements a spatial information storage device by using a database management system such as a relational database with a spatial extension. The server stores route structure information as a graph data structure, in which indoor passage sections, connection points, and elevation means are represented as nodes and edges. The server stores each passage section as an edge record containing a pair of node identifiers, a geometry object representing the path, and associated attributes including distance, type, capacity, and accessibility flags.

The server stores each connection point as a node record with a geometry, a floor level, and a connectivity list. The server stores each elevation means as a specialized edge or node with attributes indicating vertical displacement and constraints.

The server stores facility information as records associated with spatial coordinates and identifiers. The server stores moving body operation information, boarding point information, delay information, and time information either in the same database or in an auxiliary storage, and periodically updates those records by calling external information provision devices through network interfaces. The server maintains indices for spatial queries and temporal queries, thereby enabling efficient retrieval of routes and external operation data.

The terminal uses the positioning device and the short-range wireless signal generation device to generate position information that is robust inside the facility. The terminal acquires raw satellite-based positioning data including latitude, longitude, and accuracy estimates from the positioning module at a predefined sampling interval. The terminal simultaneously scans for short-range wireless signals such as beacons and measures the signal strength information. The terminal applies a sensor fusion algorithm, such as a Kalman filter or a weighted least-squares estimator, to integrate the different sources of position data into a single current position estimate aligned to the coordinate system used by the spatial information storage device.

The server receives the position information and movement request information from the terminal via network communication. The server performs validation and coordinate transformation so that the received position is expressed in the same coordinate reference system as the route structure information. The server associates the current position with a nearest node or a nearest edge in the route graph by computing spatial distances and selecting the graph element with minimal distance subject to constraints such as floor level and accessibility flags. This association reduces the discrepancy between physical position measurements and the discrete representation of routes in the digital environment, and thereby reduces the need for corrective re-routing.

The server computes optimal route information by executing a route search algorithm on the route graph. The server defines an evaluation function that combines distance information, required time information, congestion information, and usage condition information. The server represents the evaluation function as a cost function C (e) computed for each edge e, where C (e) is a weighted sum or other combination of the attributes stored in the edge record.

The server adjusts the weights based on movement request information such as preferred walking speed, avoidance of stairs, or maximum acceptable detour. The server executes a shortest-path algorithm such as Dijkstra or A* on the graph using C (e) as the cost, thereby producing a path from the node associated with the current position to the node associated with the destination. This computation is executed in memory using adjacency lists and priority queues, which reduces I/O overhead and shortens computation time.

The server acquires moving body operation information, boarding point information, delay information, and time information from external information provision devices using network communication protocols. The server parses the received data and stores schedule and delay attributes in association with particular boarding points. The server calculates movement margin time by subtracting an estimated travel time, derived from the optimal route, from a target time such as a departure or boarding time, and by adjusting the result using delay information. The server dynamically updates the evaluation function by modifying weight parameters so that, for example, when movement margin time is small, the server increases the weight on required time and decreases the weight on optional facilities. This dynamic adjustment allows the server to compute routes that are tuned to the temporal constraints at runtime, thereby reducing the number of subsequent recalculations and improving computational efficiency.

The server generates movement plan information by combining the optimal route information, the movement margin time, and facility information along or near the route. The server divides the route into route sections and, for each section, the server computes a movement distance and a required time. The server identifies facility records that are within a threshold distance from each route section using spatial queries. The server assigns time windows for optional stops based on the movement margin time and user preferences. The server generates structured data that encodes, for each route section, the start and end coordinates, the distance, the required time, the nearby facility identifiers, and any support information such as locations of assistance counters.

The server generates a prompt sentence using the structured data as a description target. The server constructs a text representation that summarizes the route sections and movement plan in a natural language-compatible form, including explicit instructions about output style. For example, the server may generate a prompt sentence such as:

“Using the following structured route data, generate concise step-by-step guidance in English for the user inside an airport. Emphasize the fastest path to the destination gate and mention any shops or services along the way that can be visited without missing the boarding time.”

The server provides the structured data, encoded in an internal representation, as additional context to the generative AI model. The server thereby separates the machine-readable route representation from the natural language description, which enables the system to reuse the same structured data for multiple types of prompt sentences and output styles.

The server implements the generative AI model as a neural network-based natural language generation engine. The server can use a transformer architecture including multiple layers of self-attention, feed-forward networks, and layer normalization modules. The server stores model parameters in a model storage unit and loads the parameters into memory for inference. The server represents the input prompt sentence and selected parts of the structured data as token sequences. The server embeds each token into a continuous vector space using learned embedding matrices. The server processes these embeddings through stacked attention blocks, each block computing attention weights over the input sequence and updating hidden states. The server applies a softmax function at the output layer to compute probability distributions over possible next tokens and selects tokens according to sampling rules such as greedy decoding or temperature-controlled sampling.

The server performs inference using fixed model parameters that have been pre-trained on a large corpus and optionally fine-tuned on domain-specific data. The server can fine-tune the generative AI model by further training it with pairs of structured route data and desired guidance texts, using a supervised learning procedure. The server computes a loss function such as cross-entropy between the model's predicted token distribution and the ground-truth tokens, and updates the weights using an optimization method such as stochastic gradient descent with adaptive learning rates. The server may also apply data augmentation, for example by generating paraphrased versions of guidance texts, to improve robustness of the model.

The server sets rules and constraints in the prompt sentence so that the generative AI model outputs text aligned with the internal route state. For example, the server may instruct that the model must not invent facilities that are not present in the structured data and must output the estimated walking time for each major segment. The server can apply post-processing to the model's output by detecting mentioned gate identifiers or facility names and matching them against the structured data. If inconsistencies are detected, the server can either request regeneration from the model with additional constraints or correct the output by aligning it with the structured data. This procedure ensures that natural language guidance remains consistent with the computed route.

The server generates natural language response information comprising guidance text, explanatory text, and support text and transmits it, together with the optimal route information, to the terminal. The server encodes the response in a communication format and uses network interfaces to send the data to the terminal. The server may compress the route representation by using polyline encodings or similar methods to reduce communication load.

The terminal receives the natural language response information and optimal route information and presents them to the user. The terminal renders the route as a line overlay on a map of the facility using a map rendering library and displays the guidance text in a panel.

The terminal updates the displayed current position as new position information becomes available. Because the server has already integrated multi-source position data and computed route segments aligned to the facility graph, the terminal can perform only lightweight rendering and interaction processing, which reduces processing load on the terminal and improves responsiveness of the user interface.

The user can input a free-form inquiry as an inquiry text that the server uses as a prompt sentence. The user may enter a question such as:

“Please tell me the fastest route to Gate A and list the shops I will pass on the way.”

The user may also input another question such as:

“I have 40 minutes before boarding at Gate B. Please suggest a route that lets me stop by a café and a duty-free shop, and make sure I can still arrive on time.”

The terminal sends the inquiry text to the server. The server constructs context information by combining the inquiry text with the current position, the optimal route information, and the movement plan information. The server encodes this context as a sequence of tokens and passes it, together with a newly generated prompt sentence, to the generative AI model. The server may specify that the model should focus on route adjustment, not on general information, by including instructions such as:

“Based on the current route and time margin, decide whether the user can safely stop at additional facilities, and if so, propose a modified route that includes those facilities.”

The server obtains response information and route change guidance information from the model and evaluates the content. The server checks whether the response proposes a route change and whether the proposed changes fit within the movement margin time and the facility constraints stored in the spatial information storage device. The server then recalculates the optimal route, if needed, by running the route search algorithm with updated constraints such as mandatory intermediate nodes representing the requested facilities. The server generates updated route information and transmits it to the terminal along with an updated guidance text.

The server analyzes state information and operation history information of the user to adjust the content and style of prompt sentences. For example, if the operation history indicates that the user frequently ignores shop recommendations, the server can modify the prompt sentence to instruct the generative AI model to shorten descriptions of shops and focus on direct navigation. If the operation history indicates that the user repeatedly asks for accessibility information, the server can add instructions to include accessibility details in every guidance text. By storing such state and history and using them to parametrize both the evaluation function and the prompt sentences, the server reduces the need for repetitive queries and recalculations, thereby improving computational efficiency.

The server thereby achieves a technical improvement in computer operation. By unifying multi-source positioning, dynamic route optimization, external operation integration, structured context generation, and generative AI-based natural language processing in a single architecture, the server reduces inconsistencies between internal route state and external guidance text that would otherwise require human correction or multiple ad hoc software modules. The server decreases the number of route recomputations by adjusting evaluation functions using movement margin time, which directly reduces processor cycles and database accesses. The server minimizes communication load by transmitting compact route representations and delegating high-complexity natural language generation to the server side, which allows the terminal to operate with limited resources.

The terminal realizes a further technical effect by using fused position information instead of a single source. By combining satellite-based positioning and short-range wireless signal strength information, the terminal delivers more accurate and stable positions to the server. This reduces error accumulation in the route graph alignment process and decreases the frequency of deviation detection and re-routing. As a result, both server and terminal consume less bandwidth and processing time than conventional systems that repeatedly correct misaligned positions.

The user benefits from more precise and timely guidance because the underlying computing system processes structured route data and external operation information through non-conventional, model-driven mechanisms. In contrast to simple automation of human work, the system applies a generative AI model that has been trained on large-scale language data and optionally fine-tuned on domain-specific route and facility descriptions. The model uses vector representations of tokens and context, high-dimensional attention weights, and learned parameters to compress and interpret complex context that would be difficult to handle with hand-written rules. The server controls the model through prompt sentences that encode system policies and technical constraints, and the server validates outputs against structured data, thereby integrating the model as a component of the routing and planning pipeline rather than as a mere text decoration tool.

In one variation, the server can employ different neural network architectures depending on resource constraints. The server may deploy a smaller transformer model for low-latency scenarios and a larger transformer model for richer explanations, switching between them based on network conditions and processor utilization. The server may also partition the model across multiple processing units for parallel inference. In another variation, the server may adjust the internal parameters such as temperature, maximum token length, or top-k sampling threshold dynamically in response to user state information and operation history, thereby optimizing the balance between output diversity and consistency.

In another embodiment, the server can integrate additional sensors, such as inertial measurement units or camera-based localization systems, into the multi-source positioning process. The server can extend the structured data to include alerts for temporary obstacles or blocked passage sections detected by facility management systems. The same route search algorithm and generative AI pipeline can adapt to these new data types by updating the evaluation function attributes and by including new fields in the structured data that are described within the prompt sentences.

In yet another embodiment, the server can apply similar techniques to different indoor environments such as logistics warehouses, industrial plants, or large commercial complexes.

The server can store different route graphs and facility records for each environment, but still use the same principles of evaluation function adjustment, structured data generation, and prompt-based generative AI interaction. This modular design confirms that the invention improves the underlying computer technology of routing and contextual language generation, rather than implementing a specific business rule or domain-specific workflow.

Through these configurations and variations, the server, the terminal, and the user cooperate in a computing environment in which route computation, context construction, and generative natural language output are closely coupled at the data structure and algorithmic levels. This coupling yields measurable technical benefits, including increased accuracy of indoor positioning and routing, reduced latency and reduced processor cycles for route updates, lower communication load through compact and consistent data exchanges, and improved robustness and maintainability of the overall software architecture.

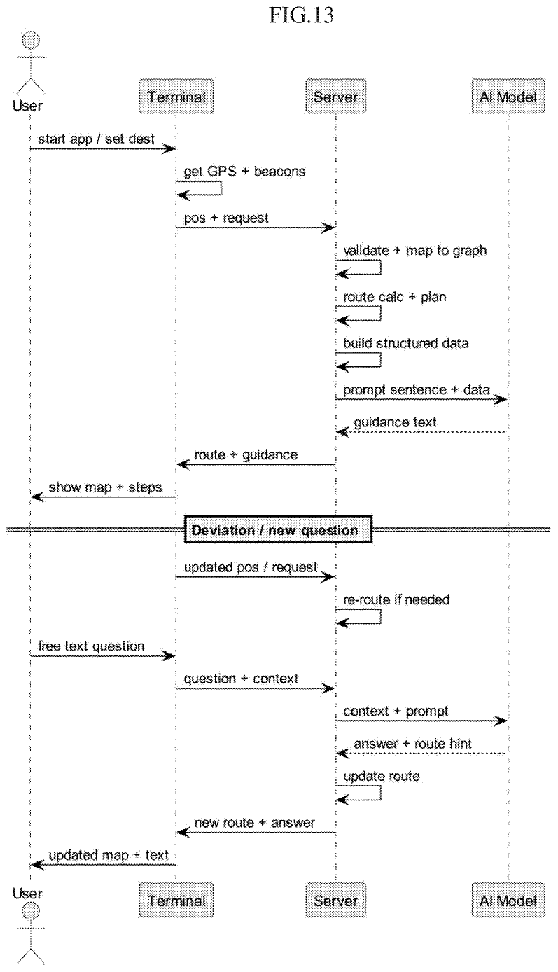

The following describes the processing flow using FIG. 13.

### Step 1:

The terminal acquires raw position data from hardware sensors. The terminal uses a positioning device to obtain satellite-based coordinates (latitude, longitude, altitude, accuracy) and uses a short-range wireless module to scan for beacon signals and measure signal strength information. The input of this step is sensor-level data from the positioning module and the short-range wireless signal generation devices. The terminal performs data acquisition and basic filtering, such as discarding outlier readings and averaging recent samples, and the output is a set of cleaned sensor readings including multiple candidate positions and associated signal strengths.

### Step 2:

The terminal fuses multiple sources of position data to generate current position information. The input of this step is the cleaned sensor readings from Step 1, including satellite-based coordinates and signal strength information from multiple beacons. The terminal executes a sensor fusion algorithm, such as a Kalman filter or weighted least squares, to compute a single current position estimate that minimizes variance between the data sources. The terminal transforms the position into the coordinate system used by the server's spatial information storage device and attaches a floor level estimate and timestamp. The output of this step is position information consisting of unified coordinates, floor level, and accuracy metrics.

### Step 3:

The terminal collects movement request information from the user. The input of this step is user actions on the graphical user interface, such as selecting a destination on a map, choosing a gate or facility from a list, or setting routing preferences (for example, avoid stairs, minimize walking distance). The terminal converts these actions into structured movement request information including destination identifiers, constraint flags, and priority settings. The output of this step is a movement request object that can be transmitted to the server.

### Step 4:

The terminal transmits the position information and movement request information to the server. The input of this step is the current position information from Step 2 and the movement request object from Step 3. The terminal serializes these into a request message, adds authentication data, and sends the message via a network interface to the server using a predefined communication protocol. The terminal may compress or batch multiple readings to reduce bandwidth. The output of this step is a network packet containing position and movement request data delivered to the server.

### Step 5:

The server receives and validates the transmitted data. The input of this step is the request packet from Step 4. The server parses the packet, verifies authentication tokens, and checks the structure and value ranges of the position information and movement request information.

The server discards corrupted or invalid entries and logs anomalies. The output of this step is a validated data set consisting of a reliable current position, a destination, and user-specific movement constraints.

### Step 6:

The server aligns the current position with the internal route graph stored in the spatial information storage device. The input of this step is the validated current position from Step 5 and the stored route structure information representing indoor passage sections, connection points, and elevation means. The server performs a nearest-neighbor search in the spatial database to find a graph node or edge closest to the current position, considering floor level and accessibility attributes. The server computes distances between the current position and candidate nodes and selects the one with the smallest distance under given constraints. The output of this step is a graph-anchored starting point for route computation.

### Step 7:

The server computes optimal route information to the requested destination. The input of this step is the graph-anchored starting point from Step 6, the destination identifier from Step 5, and route structure information including edges, nodes, and their attributes such as distance, capacity, and allowed directions. The server constructs an evaluation function that combines distance information, required time information, congestion information, and usage condition information as weighted parameters. The server then executes a graph search algorithm, such as Dijkstra or A*, on the route graph with the evaluation function as the edge cost. The output of this step is optimal route information, which includes an ordered list of nodes and passage sections forming a route from the current position to the destination, along with section-level distances and estimated travel times.

### Step 8:

The server integrates external operation information to generate movement plan information. The input of this step is the optimal route information from Step 7 and external data including moving body operation information, boarding point information, delay information, and time information obtained from external information provision devices. The server calculates an estimated travel time along the route, compares it with scheduled departure or boarding times, and derives movement margin time. The server adjusts the weights in the evaluation function to reflect urgency, and when necessary, recomputes part of the route to better satisfy temporal constraints. The output of this step is movement plan information that includes the route, movement margin time, and timing of potential intermediate stops.

### Step 9:

The server generates structured data describing the planned movement in a machine-readable format. The input of this step is the optimal route information and the movement plan information from Step 8, plus facility information stored in the spatial information storage device. The server segments the route into route sections and, for each section, associates movement distance information, required time information, nearby facility information, and support information such as assistance points. The server organizes these attributes into a structured representation, such as a sequence of section records with standardized fields. The output of this step is structured data representing route sections, timing, facilities, and support resources.

### Step 10:

The server constructs a prompt sentence for the generative AI model using the structured data. The input of this step is the structured data from Step 9 and system configuration parameters such as language preference and guidance style. The server builds a textual prompt sentence that instructs the generative AI model how to use the structured data, for example by specifying that the model should generate step-by-step navigation, summarize key timing constraints, and mention particular facility types. The server may include explicit instructions restricting the model to only refer to entities present in the structured data. The output of this step is a prompt sentence paired with the structured data as contextual input.

### Step 11:

The server invokes the generative AI model to produce natural language response information. The input of this step is the prompt sentence and structured data from Step 10.

The server tokenizes the prompt sentence and relevant parts of the structured data, embeds the tokens into numerical vectors, and feeds them through a neural network implementing a transformer architecture with self-attention layers. The generative AI model performs internal computations to predict a sequence of output tokens that form guidance text, explanatory text, and support text. The server decodes the tokens into natural language strings and may enforce constraints such as maximum length and required elements. The output of this step is natural language response information aligned with the route and movement plan.

### Step 12:

The server validates and refines the natural language response information using the structured data. The input of this step is the natural language response information from Step 11 and the structured data from Step 9. The server extracts referenced facility names, gate identifiers, and step counts from the generated text and compares these with the structured data. When inconsistencies are detected, the server edits the text or regenerates parts of it by issuing an adjusted prompt sentence that clarifies constraints. The output of this step is a validated natural language response that is consistent with the internal route representation.

### Step 13:

The server transmits the optimal route information, movement plan information, and natural language response information to the terminal. The input of this step is the validated output from Steps 7, 8, and 12. The server formats the route as an efficient representation such as a compressed polyline, bundles it with timing metadata and the natural language guidance text, and encapsulates the combined data into a response message. The server sends this message over the network to the terminal. The output of this step is a delivered response packet containing route, plan, and guidance content.

### Step 14:

The terminal receives the response packet and prepares data for presentation. The input of this step is the response message from Step 13. The terminal parses the packet, decodes the polyline into a list of coordinates, and extracts section-level times, facility references, and the natural language response information. The terminal maps facility identifiers to local icons and labels and constructs internal data structures for rendering the route on a map and for displaying text instructions. The output of this step is a set of display-ready objects including graphical route data and textual guidance segments.

### Step 15:

The terminal displays the route and guidance to the user and monitors the user's progress. The input of this step is the display-ready objects from Step 14 and updated position information from Step 2. The terminal draws the route onto the facility map, positions a marker at the user's current location, and renders the guidance text in a dedicated area of the screen. As new position updates arrive, the terminal animates the marker and highlights the current route section. The output of this step is a continuously updated visual and textual guidance interface presented to the user.

### Step 16:

The user follows the displayed guidance and optionally adjusts preferences. The input of this step is the on-screen route visualization and natural language instructions from Step 15. The user moves along the indicated path, reads instructions such as distances and turns, and decides whether to visit nearby facilities suggested in the guidance text. The user may also change preferences or select a new destination through the user interface. The output of this step is updated user actions that can trigger new movement requests or inquiries.

### Step 17:

The terminal detects deviations or new user actions and informs the server. The input of this step is the sequence of current positions from Step 2, the route data from Step 14, and user interaction events from Step 16. The terminal compares the trajectory of current positions with the expected route geometry to estimate deviation. When a threshold deviation or a destination change is detected, the terminal generates an updated movement request containing the new position and conditions and transmits it to the server. The output of this step is a new request packet indicating a need for route recalculation or adaptation.

### Step 18:

The user submits a free-form inquiry that will serve as an additional prompt sentence. The input of this step is the user's need for further information or assistance, for example time constraints or special preferences. The user types a question such as “Please show me the fastest way to Gate A and tell me which shops I will pass,” or “I have 40 minutes before boarding at Gate B. Please suggest a route that lets me stop by a café and a duty-free shop, and make sure I can still arrive on time.” The terminal captures this inquiry text and packages it for transmission. The output of this step is inquiry text that expresses a user-specific request in natural language.

### Step 19:

The terminal transmits the inquiry text and context information to the server. The input of this step is the inquiry text from Step 18, the current position from Step 2, and the current route and movement plan stored locally from previous steps. The terminal packages these into a request including context fields and sends the request to the server. The output of this step is a context-rich query packet delivered to the server.

### Step 20:

The server constructs enhanced context information and a specialized prompt sentence for the generative AI model. The input of this step is the context-rich query packet from Step 19 and the internal state including stored route, facility, and operation information. The server aggregates the current position, active route, movement margin time, user preferences, and the inquiry text into a unified context representation. The server then generates a specialized prompt sentence that instructs the generative AI model to consider this context and to decide whether and how to modify the route, while respecting timing and accessibility constraints. The output of this step is an enhanced context object and a specialized prompt sentence tailored to the user's inquiry.

### Step 21:

The server uses the generative AI model to generate response information and route change guidance information based on the enhanced context. The input of this step is the specialized prompt sentence and context object from Step 20. The server encodes these inputs as token sequences, feeds them to the generative AI model, and obtains output tokens representing an answer. The generated content includes recommendations such as whether to add intermediate stops, which facilities to include, and how to rephrase navigation instructions.

The server decodes the tokens into natural language and extracts route change guidance information such as required detours or new intermediate waypoints. The output of this step is a combination of response information and structured route change guidance.

### Step 22:

The server recalculates route information using the route change guidance and generates updated route information. The input of this step is the route change guidance from Step 21 and the existing route structure information and spatial data. The server modifies the route computation constraints, for example by requiring inclusion of specified facilities as intermediate nodes or by adjusting the evaluation function weights according to updated time constraints. The server runs the route search algorithm again to generate a revised optimal route that satisfies the user's new requirements. The output of this step is updated route information suitable for immediate navigation.

### Step 23:

The server composes an updated guidance response and sends it to the terminal. The input of this step is the updated route information from Step 22 and the response information from Step 21. The server updates or regenerates structured data for the new route, optionally creates a refined prompt sentence to ensure consistency, and validates the guidance text against the new structured data. The server then sends the updated route, new movement plan, and updated guidance text to the terminal. The output of this step is a response packet that instructs the terminal how to present the modified route and explanations.

### Step 24:

The terminal receives the updated route and guidance and refreshes the displayed information. The input of this step is the response packet from Step 23. The terminal parses the new route representation, replaces or overlays the existing route on the map, and updates the textual guidance panel with the new description. The terminal may highlight newly added facilities or changes in the path to draw user attention. The output of this step is an updated user interface that reflects the revised navigation plan.

### Step 25:

The user continues navigation based on the updated guidance and the system's dynamic adjustments. The input of this step is the refreshed route visualization and updated guidance from Step 24. The user proceeds along the newly suggested route, optionally stopping at recommended facilities, and benefits from route adjustments that are computed by the server based on precise positioning, temporal optimization, and generative AI-based context processing. The output of this step is ongoing movement and interaction data that can be captured by the system for further optimization and learning.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional mobility-support and facility-guidance systems are typically implemented as a collection of independent components: a routing engine for calculating paths, a timetable or vehicle-status feed for real-time movement information, a directory service for facilities, a separate campaign engine for promotions, and, at most, a basic rules engine for simple personalization. These components are loosely coupled and rely on fixed, hand-crafted rules and static parameter settings. As a result, such systems exhibit several technical limitations.

First, existing systems are not well suited to processing heterogeneous, natural-language movement requests and rich context information on a computing device. When a user expresses an intent in free text or speech (for example, combining constraints on time, stress level, preferences, and intermediate stops), conventional systems require multiple intermediate parsing layers and brittle pattern-matching logic. This increases CPU and memory overhead, leads to high latency, and often produces inaccurate or incomplete internal representations of the request, which degrades subsequent routing and information-retrieval performance.

Second, the routing pipeline in conventional systems is largely unaware of user state and environmental context beyond raw position coordinates. Route search algorithms typically operate on a static graph with fixed cost parameters and do not adapt dynamically to real-time emotional or physiological signals from the user, or to complex trade-offs such as “shortest path subject to stress reduction.” As a consequence, the computing resources of the routing engine are spent recomputing generic shortest paths, even when such paths are not appropriate for the user's current condition, and the system fails to efficiently generate routes that align with real-time user state.

Third, current systems treat the acquisition and presentation of facility information and promotion information as a separate, post-processing step. Facilities and promotions are often retrieved via simple radius-based queries around the current position, independently of the actual path geometry. This architecture forces the application to run additional spatial queries on the client or server, which increases network traffic and processing cost, leads to redundant database access, and causes inconsistencies between displayed routes and displayed facilities or promotions. In particular, the system cannot efficiently compute “route-associated information” that is intrinsically tied to the sequence of waypoints and the evolving user state.

Fourth, emotion recognition and biometric sensing are either entirely absent or implemented as isolated modules whose outputs are only loosely used to change user-interface themes or notification frequency. These emotion modules are not integrated into the core computation path that generates route plans and associated content. Thus, computing resources devoted to sensing and classifying emotion or stress are not leveraged to adjust the internal behavior of the routing, facility selection, or promotion-selection algorithms. The overall software stack, from prompt generation to route search parameters, remains static, resulting in suboptimal utilization of the available computing capabilities and poor responsiveness to user state.

Fifth, in many architectures the use of generative AI models is limited to separate, user-facing chat functions or documentation generation. The generative AI component is not systematically used as an internal planning and orchestration engine that generates machine-readable prompt sentences, decomposes natural-language inputs into structured constraints, and helps classify incoming requests into different backend service flows. Because of this, the server is forced to maintain complex, hand-written control logic for classifying and dispatching requests, which increases code complexity, creates maintenance burdens, and restricts the ability of the system to learn from accumulated user interaction data.

Moreover, feedback loops for continuous adaptation are weak or absent. While some systems log usage statistics, they do not explicitly store and exploit rich feedback data, such as emotion-related information, route choices, skipped suggestions, or accepted promotions, as structured learning data for improving prompt-generation rules or route-search parameters. Therefore, server-side components cannot adaptively reconfigure themselves based on historical outcomes, and the computational behavior of the system remains largely fixed, regardless of changing user populations or environments.

Accordingly, there is a need for a computer-implemented system and server architecture that: (i) uses a generative AI model in a tightly integrated manner to parse and classify heterogeneous user movement requests, (ii) generates and maintains route-associated information including facility and promotion data as a first-class computational object, (iii) incorporates real-time biometric and emotion information into the core routing and content-selection algorithms, and (iv) employs accumulated feedback to update prompt-generation rules and search parameters. Such a system should improve the efficiency, adaptability, and responsiveness of the underlying computer processes, rather than merely adding application-level features, thereby constituting a concrete improvement to computer technology in the field of context-aware routing and information provision.

The specific processing by the specific processing unit 290 of the data processing device 12 in Application Example 2 is realized by the following means.

The present invention provides a server comprising at least one processor and at least one memory storing instructions that, when executed by the processor, cause the processor to perform operations including: receiving, from a user terminal device, position information and movement request information; generating a prompt sentence for a generative AI model based on the received position information and movement request information; inputting the prompt sentence into the generative AI model and causing the generative AI model to analyze natural language information including the movement request information and to output structured data including destination information and user attribute information; calculating route information from a current position to a destination based on the destination information by using route network data stored in a geographic information storage and a route search algorithm, acquiring operation information of a moving body along the route information via an external information providing apparatus, and generating and outputting real-time moving body information; acquiring facility information located in proximity to the route information by performing spatial search on a facility information storage based on the route information; acquiring promotion information from a promotion information storage associated with the facility information; generating route-associated information by integrating the route information, the facility information, and the promotion information; transmitting the route-associated information to the user terminal device as a unified response; successively updating the current position based on measurement information from a position detection device obtained from the user terminal device, and, when the current position deviates from the route information by more than a predetermined condition, recalculating the route information and the route-associated information and transmitting update information to the user terminal device; estimating a psychological state of a user based on biometric information obtained from a biometric information acquisition device and emotion information obtained from an emotion state recognition device; when the psychological state satisfies a predetermined condition, generating a prompt sentence for the generative AI model including the psychological state and facility information as context, inputting the prompt sentence into the generative AI model, and causing the generative AI model to generate adjusted movement plan information including relaxation route information and relaxation content information; adjusting a service presented to the user terminal device based on the adjusted movement plan information so as to include at least one of rest facility information, quiet environment information, and calming presentation information; accumulating emotion-related information, movement history information, and service selection information obtained from the user terminal device in a learning storage; and, based on accumulated information, updating generation rules of prompt sentences for the generative AI model and parameters of the route search algorithm to adaptively improve subsequent route proposals and information provision. This enables the server to internally orchestrate routing, facility selection, promotion selection, and stress-aware content generation as a unified, context-driven computation that reduces reliance on rigid, hand-coded control logic, improves the efficiency of route and content computation, dynamically tailors processing to real-time user state, and adaptively reconfigures core algorithms and prompt strategies based on feedback, thereby providing a concrete improvement to computer-implemented routing and information-provision technology.

The term “processor” refers to one or more hardware processing units, such as a central processing unit or a graphics processing unit, configured to execute instructions to perform the operations described herein.

The term “memory” refers to a non-transitory computer-readable storage medium, such as semiconductor memory, magnetic storage, or optical storage, that stores instructions and data for execution by the processor.

The term “user terminal device” refers to an information processing apparatus operated by a user, such as a portable communication device, a wearable device, or a general-purpose computing device, configured to transmit and receive data to and from the server.

The term “position information” refers to data indicating a geographic or spatial location of the user terminal device, such as coordinates, floor level, or derived location parameters obtained from a position detection device.

The term “movement request information” refers to data representing a user's intention regarding movement, including at least one of a destination, a time constraint, a route preference, or a natural-language instruction related to movement.

The term “prompt sentence” refers to a machine-readable instruction string provided as input to a generative AI model, the instruction string specifying how the generative AI model should analyze, transform, or generate information.

The term “generative AI model” refers to a trained machine learning model configured to generate output data, such as structured information or natural-language text, in response to an input prompt sentence.

The term “natural language information” refers to information expressed in a human language, including text or transcribed speech, that encodes user intentions, constraints, or preferences.

The term “destination information” refers to structured data identifying a target location, such as a facility identifier or geographic coordinates, that is derived from movement request information.

The term “user attribute information” refers to structured data describing characteristics of a user, such as preference information, behavioral tendencies, or classification labels used for personalization.

The term “geographic information storage” refers to a storage structure, such as a database, that retains route network data, map data, and related spatial information used for calculating route information.

The term “route network data” refers to graph-structured or equivalent data representing navigable paths, nodes, and connectivity between locations within an area.

The term “route search algorithm” refers to a computational method, such as a shortest-path or cost-minimization algorithm, used to determine a route between two or more positions in route network data.

The term “route information” refers to data representing a computed path between a current position and a destination, including at least one of waypoints, path geometry, distance, or estimated travel time.

The term “moving body” refers to a physical transport entity, such as a vehicle, a transit unit, or another conveyance, whose operational status is relevant to a user's movement.

The term “real-time moving body information” refers to time-sensitive data concerning a moving body, including at least one of its current position, schedule, delay status, or boarding information.

The term “external information providing apparatus” refers to an external system or service, such as a remote server or data feed source, that supplies operational data of moving bodies or other dynamic information.

The term “facility information storage” refers to a storage structure, such as a database, that retains information about facilities, including location data, type classifications, and service attributes.

The term “facility information” refers to data describing a facility, such as its identifier, category, geographic location, opening hours, and available services.

The term “promotion information storage” refers to a storage structure that retains information about promotional activities, such as discounts, campaigns, and associated facility identifiers.

The term “promotion information” refers to data describing a promotional activity associated with a facility, including validity periods, benefit details, and display content.

The term “spatial search” refers to a computational operation that retrieves records from a storage structure based on spatial relationships, such as distance from a route or proximity to a position.

The term “route-associated information” refers to combined data that includes at least route information and facility and promotion information linked to the route information.

The term “position detection device” refers to a sensing component, such as a location sensor, that provides measurement information enabling determination or estimation of the position of a user terminal device.

The term “measurement information” refers to raw or preprocessed sensor data output from a position detection device, used to update the current position of a user.

The term “biometric information acquisition device” refers to a sensing component, such as a physiological sensor, that measures biometric signals including heart rate, blood pressure, or related bodily indicators.

The term “emotion state recognition device” refers to a component or processing module that estimates an emotional state of a user based on input data, such as facial expressions, voice signals, or text.

The term “biometric information” refers to data representing physiological characteristics of a user, including at least one of heart rate, heart rate variability, or other measurable bodily signals.

The term “emotion information” refers to data indicating an estimated emotional state of a user, such as stress, calmness, joy, or frustration.

The term “psychological state” refers to an inferred internal state of a user derived from biometric information, emotion information, or both, indicating at least one of stress level, arousal, or relaxation.

The term “adjusted movement plan information” refers to movement-related data generated in consideration of a psychological state, including at least one of a modified route and associated supportive content.

The term “relaxation route information” refers to route information that is selected or generated to reduce user stress by taking into account facilities or path characteristics suitable for relaxation.

The term “relaxation content information” refers to data specifying content intended to promote relaxation, such as guidance to rest areas, audio content, or visual content.

The term “rest facility information” refers to facility information identifying locations suitable for rest, such as lounges, seating areas, or quiet zones.

The term “quiet environment information” refers to data identifying locations or periods associated with reduced noise or disturbance levels.

The term “calming presentation information” refers to content designed to alleviate stress, such as visual messages, audio cues, or recommendations for calming activities.

The term “service” refers to a type of information provision or function offered by the system, including at least routing, facility guidance, promotion display, or support provision.

The term “learning storage” refers to a storage structure configured to retain interaction data, including emotion-related information, movement history, and service selection information, for later analysis or model adaptation.

The term “emotion-related information” refers to data derived from emotion information or user interactions that indicates user emotional responses to system behavior.

The term “movement history information” refers to data recording past movement patterns of a user, including previously selected routes, visited facilities, and timing information.

The term “service selection information” refers to data indicating which services or suggestions presented by the system were accepted, ignored, or rejected by the user.

The term “generation rules of prompt sentences” refers to logic, parameters, or templates that determine how prompt sentences are automatically constructed for input to a generative AI model.

The term “parameters of the route search algorithm” refers to adjustable values used by a route search algorithm, such as cost weights, penalty values, or preference scores, that influence route calculation.

The term “analysis results” refers to structured outputs obtained by processing input data using the generative AI model, classifiers, or other computational components.

The term “real-time moving body information providing service” refers to a service that delivers real-time moving body information to the user terminal device based on current context.

The term “movement plan generation service” refers to a service that creates and outputs a movement plan, such as a route and schedule, in response to movement request information.

The term “facility guidance service” refers to a service that provides guidance to one or more facilities, including route information and facility descriptions.

The term “surrounding information providing service” refers to a service that supplies information about facilities or points of interest in the vicinity of a user's position or route.

The term “trouble response support service” refers to a service that provides alternative routes, alternative movement means, or assistance when problem occurrence information is detected.

The term “problem occurrence information” refers to data indicating an event that interferes with planned movement, such as a delay, closure, or incident.

The term “alternative route information” refers to route information that replaces or supplements an original route in response to problem occurrence information.

The term “alternative movement means information” refers to data specifying another mode or option of movement, such as a different transport type, when an original movement means is unavailable or unsuitable.

The term “support information” refers to guidance, instructions, or contact information provided to assist a user in resolving a detected problem.

The term “natural language inquiry sentence” refers to a sequence of words in a human language entered or spoken by a user to request information or service.

The term “time condition” refers to a constraint related to time, such as a deadline, duration, or available time window extracted from a natural language inquiry sentence.

The term “movement constraint condition” refers to a constraint related to movement, such as maximum walking distance, accessibility requirements, or route complexity limits.

The term “preference condition” refers to a constraint or tendency expressing user preferences, such as preferred facility types, noise levels, or price ranges.

The term “candidate visit location” refers to a facility or place that satisfies at least part of extracted conditions and is considered as a potential destination for the user.

The term “ranking” refers to an ordered arrangement of candidate visit locations according to one or more evaluation criteria.

The term “recommendation reason information” refers to data explaining why a candidate visit location was selected or ranked in a particular way.

In one embodiment, a server implements the claimed system as a network-connected computing platform composed of at least one processor, at least one memory, a non-volatile storage device, and a communication interface. The server executes a set of software modules including an API layer, a routing engine, a spatial query engine, a facility and promotion management module, a biometric and emotion processing module, a prompt-generation module for a generative AI model, and a learning and adaptation module. The server may be implemented on a general-purpose computer running a server-class operating system, and may be deployed in a data center or cloud environment.

In one embodiment, a terminal is implemented as a mobile communication device such as a smartphone, a tablet, or a wearable device. The terminal includes a processor, a memory, a display, an input interface, a communication interface, a position detection unit (for example, a satellite positioning receiver or a wireless beacon receiver), and optionally a biometric sensing interface and an image and audio capture interface. The terminal executes an application that communicates with the server, displays route-associated information, captures user input, and relays sensor data.

In one embodiment, a user operates the terminal to input natural language movement requests and interacts with the displayed route guidance and associated information. The user may also wear a separate biometric information acquisition device, such as a wrist-worn physiological sensor that transmits heart-rate and related data to the terminal via a short-range wireless link.

In one embodiment, the server stores route network data in a geographic information storage implemented as a graph database or a relational database with a graph representation. The server represents the route network as a directed or undirected graph whose vertices represent locations, such as corridor intersections, facility entrances, or transport stops, and whose edges represent navigable segments with associated attributes. The server assigns each edge a vector of cost components, such as physical distance, expected traversal time, number of turns, and “stress-sensitive” penalties for crowded or noisy segments. The server also stores facility information in a facility information storage, which maps facility identifiers to attributes such as category, opening hours, coordinates, and noise profiles. The server stores promotion information in a promotion information storage, which refers to facility identifiers and records campaign attributes such as discount levels, active periods, and priority scores. In one embodiment, the server implements the generative AI model as a neural network-based language model that has been trained on textual data and fine-tuned with structured labels for extraction tasks relevant to routing and facility selection. The generative AI model includes an embedding layer that converts tokens in a prompt sentence into dense vectors, a sequence of attention-based transformation layers that capture contextual relationships between tokens, and an output layer that produces probability distributions over tokens or structured tags. The server stores the model weights in the memory and loads them into the processor for inference.

In one embodiment, the server uses the generative AI model in a non-conventional manner as an internal planner. The server does not merely implement a chat interface, but instead constructs machine-oriented prompt sentences that encode both raw user movement request information and pre-defined instruction templates. For example, the prompt sentence may be: “Given the user query: ‘I want to go from the security check to a quiet restaurant within 20 minutes’, and given the available facility categories, extract: (1) a destination facility type, (2) a maximum walking time, and (3) any user preference tags. Output a JSON-like triple (destination_type, max_time_minutes, preference_tags) in one line.”

In another example, the prompt sentence may be:

“Given the user query: ‘Show the best sushi restaurants I can visit inside this terminal within 40 minutes before my flight’, and the following structured entries for restaurants, compute which entries satisfy the time constraint and rank them by suitability. Output the top 5 restaurant IDs with a short explanation for each.”

In another example, when the server detects a high stress level, the prompt sentence may be: “The user is highly stressed, is in Area B, and has 45 minutes until departure. Suggest a short relaxation plan using only facilities from this list. Respond with 2-3 concrete steps in plain language.”

The server converts the textual output of the generative AI model into structured internal representations by applying deterministic parsers and validators, and thus ensures that the model output is integrated into further algorithmic processing.

In one embodiment, the server implements the prompt-generation module as a rule-based and data-driven component that composes prompt sentences according to a set of templates and context variables. The server selects which template to use based on the type of movement request information (for example, pure destination input, preference-rich query, stress-responsive scenario) and on user attribute information stored in the learning storage.

The server encodes context information, such as approximate remaining time, recent facility usage, and stress level, into the prompt sentence so that the generative AI model can condition its output on those variables. This combination of explicit template rules and context-dependent parameters allows the system to generate prompts that are specific and constrained, which reduces ambiguity in the model output and improves extraction accuracy. In one embodiment, the server configures the generative AI model for structured extraction by fine-tuning it on training pairs consisting of prompt sentences and desired outputs, where the outputs encode specific fields such as destination type, time constraint, movement constraint condition, and preference condition. The server uses a sequence-to-sequence learning objective with a cross-entropy loss function over target tokens. During fine-tuning, the server performs gradient-based optimization to adjust the model weights so that the generated output tokens match the annotated structured outputs. The server may employ data augmentation techniques, such as paraphrasing user queries or varying constraints, to increase the robustness of the model to different phrasings.

In one embodiment, the server integrates the generative AI model's output with the route search algorithm by converting extracted constraints into cost functions and filters applied to the route network graph. For example, if the extracted movement constraint condition specifies a maximum walking duration, the server sets upper bounds on acceptable path lengths; if the preference condition gives high priority to quiet routes, the server increases the cost of edges tagged as noisy. The server then invokes a multi-criteria pathfinding algorithm that computes not only a single shortest path but a Pareto-optimal set of routes, and selects one route based on a combination of user attributes and system-defined policies. This integration yields technically improved performance compared to a fixed-parameter route search engine because the search space is pruned earlier and cost functions are dynamically adapted to each query.

In one embodiment, the server implements the spatial query engine using a database extension that supports geometric types. The server stores the route geometry as polylines and the facility locations as points in a spatial index. After computing route information (for example, a set of line segments), the server performs a spatial join between the route geometry and the facility points within a specified buffer distance. This operation retrieves only those facility records that lie close to the route, thus reducing the volume of facility data that must be considered. The server also filters promotions associated with those facilities by checking current time and campaign status. Because the spatial join is performed once per route update, and the resulting route-associated information is cached as a single composite object, the server reduces repeated querying and transmission of redundant facility and promotion data. This architecture reduces network load and processing overhead on both server and terminal.

In one embodiment, the server defines the data structure for route-associated information as a composite record that includes at least: an ordered list of waypoints with coordinates and timestamps, a list of facility entries each containing an identifier, category, and position along the route, and a list of promotion entries each linked to a facility entry. The server may assign each entry a unique key and include pre-computed metrics such as detour time or user-specific preference scores. By transmitting this composite object as a unified response, the server minimizes the number of round-trips and enables the terminal to render the map and the facility list without additional queries.

In one embodiment, the terminal receives route-associated information and draws the route geometry on a map display. The terminal marks facilities and promotions with icons or textual overlays. The terminal may cache the received data locally, so that minor user movements do not require a full re-load from the server, which further reduces communication load.

In one embodiment, the server processes biometric information and emotion information in order to estimate a psychological state of the user. The server receives heart-rate data and optionally heart-rate variability or other biometric features from the biometric information acquisition device through the terminal. The server also receives emotion information from an emotion state recognition device that has analyzed facial expressions or vocal characteristics. The server normalizes these inputs by resampling them at consistent time intervals and calculating derived features such as short-term and long-term averages, deviations, and gradients. The server then feeds these features into a supervised learning model, such as a neural network with fully connected layers, which has been trained to output a stress score. The server may use a loss function such as mean squared error during training and adjust the model weights to minimize the error between predicted and reference stress levels.

In one embodiment, the server uses the estimated psychological state as a parameter that influences both prompt-generation and route-search behavior. When the stress score exceeds a threshold, the server changes the prompt-generation template so that the generative AI model is instructed to propose relaxation-oriented actions instead of only shortest routes. In addition, the server modifies the route search algorithm by increasing the cost of edges that pass through known crowded zones and by favoring edges that lead past rest facilities or quiet areas. Because these parameters are adjusted internally in the server's algorithms, the system performs a different computational procedure in response to the same physical environment when the user state changes, thereby improving both the efficiency and relevance of route proposals.

In one embodiment, the server uses the generative AI model to generate adjusted movement plan information based on a combination of extracted constraints and the psychological state. For example, when the psychological state indicates high stress and a short remaining time, the server may use a prompt sentence such as:

“The user is in the departure hall, has 30 minutes before boarding, and has a high stress level. Using only the following list of facilities, choose one recommended sequence of up to 3 actions that fits within the time and reduces stress. Output the sequence with short, imperative instructions.”

The server parses the resulting textual sequence and maps facility references back to facility identifiers in the facility information storage. The server then generates one or more candidate “relaxation routes” that link the current location, the suggested facilities, and the final departure gate. Compared to a manual approach, this system automatically explores alternative route configurations that may not be captured by simple rules, and it does so by integrating a model's generative capabilities with precise graph-based routing.

In one embodiment, the server accumulates emotion-related information, movement history information, and service selection information in a learning storage. For each interaction, the server stores a record containing the movement request information, the prompt sentence used, the generative AI model outputs, the selected route, the psychological state estimate, and whether the user followed or rejected certain suggestions. The server periodically runs an offline training process that updates the generation rules of prompt sentences and the parameters of the route search algorithm. For example, the server can optimize prompt templates by measuring which combinations of instructions and context fields yield the most reliable and useful model outputs, and can adjust edge cost weights to match observed user choices. This feedback-driven adaptation leads to better alignment between internal computational decisions and real user behavior, and thus improves accuracy and responsiveness over time.

In one embodiment, the system improves computer technology beyond simple automation of human judgment by reorganizing the internal data flow and computation within the server. The tight coupling between (i) generative AI-based extraction and planning, (ii) graph-based route search with dynamic cost adjustment, and (iii) spatially joined facility and promotion data, reduces redundant computations. For example, once the server has produced route-associated information for a user, it can reuse parts of this object for subsequent incremental updates, instead of recomputing facility proximity from scratch. In addition, because the generative AI model is restricted by explicit prompt templates and validated outputs, the system avoids excessive, unpredictable processing that would otherwise increase latency and resource usage. These design choices yield lower average response times and reduced server CPU utilization for a given volume of requests.

In one embodiment, the server reduces communication bandwidth by deliberately packaging route geometry, facility information, and promotion information into a single route-associated information object. The server further encodes only facilities that lie within a threshold distance from the route and only promotions that are currently active. As a result, the size of each response payload is lower than in conventional systems that request and transmit broad area facility lists. The reduction in redundant data contributes to more efficient use of network resources in environments with limited bandwidth, such as crowded transport hubs.

In another embodiment, the server uses different model architectures or algorithms as alternatives. The generative AI model may be replaced or supplemented with a sequence labeling model that tags tokens in the movement request information with roles, or with a hybrid model that uses neural networks to propose candidates and rule-based logic to verify consistency. The route search algorithm may be implemented as a multi-level graph search that first computes a coarse path on an abstracted graph and then refines it at a finer level, thereby reducing search time in large networks. These alternative designs still adhere to the core concept of integrating generative AI-based constraint extraction with dynamic route search and route-associated information generation.

In another embodiment, the emotion state recognition device may be implemented on the terminal using an on-device neural network inference engine. The terminal analyzes camera frames and microphone signals to infer emotion labels and transmits only the labels and confidence scores to the server, thereby reducing the amount of personal data sent over the network and lowering bandwidth usage. The server then uses these labels as part of the psychological state estimate and service adjustment process described above.

In another embodiment, the system operates in different environments, such as indoor facilities, mixed indoor-outdoor areas, or moving-body environments. In a moving-body environment, the server may run in a computing unit installed on a transport unit and use local sensors for position and status. The terminal interacts with the local server to receive up-to-date route-associated information that takes into account both the motion of the transport unit and the state of the user.

In all of these embodiments, the server, the terminal, and the user cooperate to implement the claimed system. The server performs the primary data processing, including generative AI-based analysis, route computation, spatial association, psychological state estimation, and adaptive updates to algorithms and prompt strategies. The terminal collects sensor data, displays route-associated information and relaxation content, and transmits user inputs and feedback. The user specifies movement requests and interacts with the guidance. This configuration results in a technical architecture that dynamically optimizes computation and communication based on user context and state, rather than executing a fixed, generic routing procedure, thereby providing a concrete and specific improvement to computer-implemented routing and information-provision systems.

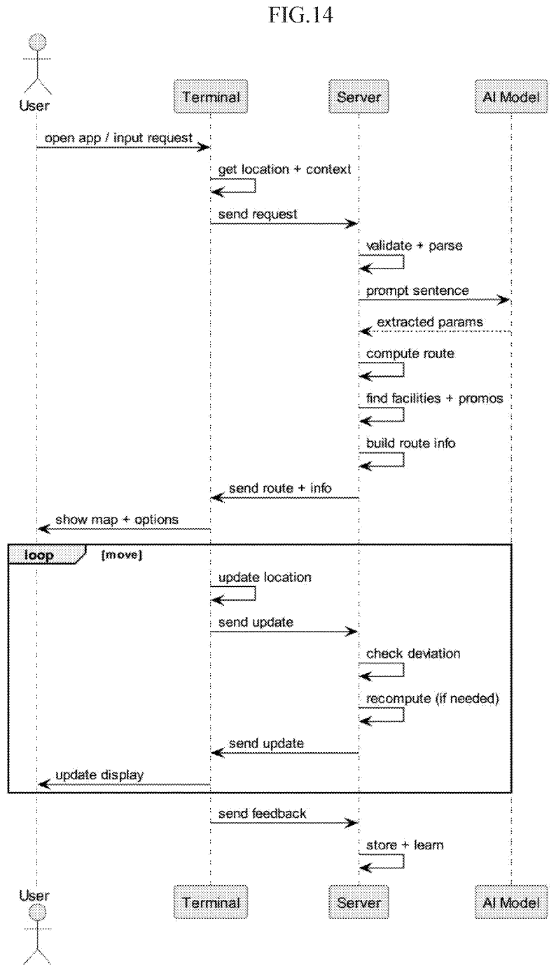

The following describes the processing flow using FIG. 14.

### Step 1:

Terminal initializes the application and sensors.

Terminal starts a mobility-support application, allocates memory buffers, and initializes interfaces to a position detection unit (for example, a satellite positioning module or a wireless beacon interface), a network communication module, and optionally a biometric interface and a camera/microphone interface.

Input: device configuration data and operating system APIs.

Output: an initialized runtime state including sensor handles and a ready user interface.

Terminal invokes OS-level APIs to request location updates, sets sampling intervals (for example, every few seconds), and prepares UI elements such as a text input field for movement requests, buttons, and a map canvas.

### Step 2:

User provides movement request information.

User opens the application on the terminal and inputs movement request information as natural language text or speech, such as “I want to go from security check to Gate 32 passing by a quiet café” or “Show the best sushi restaurants I can visit within 40 minutes.”

Input: display of the terminal UI and input widgets.

Output: raw movement request information in textual form stored in terminal memory.

Terminal converts speech to text using a local or external speech-to-text service when necessary, normalizes character encoding, and caches the resulting string.

### Step 3:

Terminal acquires current position and context data.

Terminal reads position information from the position detection unit (satellite coordinates outdoors, beacon-based location indoors), optionally reads current floor level, and may retrieve current biometric samples (for example, heart rate) from a connected wearable device.

Input: sensor measurements from the position detection unit and optional biometric interface.

Output: a context packet containing position information, timestamp, optional biometric features, and the movement request string.

Terminal fuses multiple sensor readings, filters obvious outliers, and formats the combined data into a structured record for transmission.

### Step 4:

Terminal transmits movement request and position to the server.

Terminal opens a secure network connection, encodes the context packet as a structured message, and attaches identification and authentication tokens.

Input: context packet and stored credentials.

Output: a network request sent to the server containing movement request information, position information, and optional biometric information.

Terminal may compress the payload and set transmission headers to reduce bandwidth and latency.

### Step 5:

Server receives and validates the incoming request.

Server accepts the network request at an API endpoint, parses the structured message, and verifies authentication and data formats.

Input: structured request from the terminal.

Output: validated input objects including a movement request string, a current position vector, and optional biometric and device metadata.

Server checks JSON schemas, verifies that coordinates lie within a configured operating area, and logs request identifiers for monitoring.

### Step 6:

Server generates a prompt sentence for the generative AI model.

Server selects a prompt template according to the type of movement request and context (for example, destination search, restaurant ranking, or stress-aware assistance).

Input: movement request string, current position, and optionally psychological context flags (for example, high stress).

Output: a prompt sentence that encodes instructions to the generative AI model.

Server fills template slots with user text and numeric constraints, for example:

“The user query is: ‘I want to go from the security check to Gate 32 passing by a quiet café.’ Extract: (1) destination gate identifier, (2) intermediate facility type, (3) any time constraints. Output one line formatted as (destination_id, facility_type, time_limit_minutes).”

### Step 7:

Server invokes the generative AI model and parses its output.

Server inputs the prompt sentence into the generative AI model, runs inference, and receives model output tokens.

Input: prompt sentence string.

Output: structured fields such as destination information, movement constraint conditions, and preference conditions.

Server applies a deterministic parser to the model output, checks syntax (for example, presence of expected delimiters), validates field types (for example, integer time limits), and maps textual identifiers to internal IDs (for example, facility categories and gate IDs) using lookup tables. If parsing fails, server may fall back to alternative templates or rule-based extraction.

### Step 8:

Server determines user psychological state.

Server computes a psychological state estimate using biometric information and emotion information when available.

Input: biometric features from the wearable, emotion labels from an emotion state recognition device, and historical emotional patterns from learning storage.

Output: a psychological state object including a stress score and state class (for example, low, medium, high).

Server normalizes sensor values, calculates derived features such as moving averages and variability, and inputs them to a trained neural network or other classifier. The server compares the resulting stress score to predefined thresholds and labels the state accordingly.

### Step 9:

Server computes base route information using route network data.

Server loads route network data from geographic information storage and calculates at least one path from the current position to the destination.

Input: current position, destination information, and route network graph.

Output: base route information including an ordered list of nodes, edges, distances, and estimated travel times.

Server creates an initial cost function that may consider distance and travel time, and runs a route search algorithm (for example, Dijkstra-based or A* search). Server stores the resulting path as a sequence of node identifiers with associated geometry.

### Step 10:

Server adapts route search parameters using extracted constraints and psychological state.

Server adjusts edge costs and constraints based on movement constraint conditions, preference conditions, and psychological state.

Input: base route information, movement constraints, preference conditions, and psychological state object.

Output: adjusted cost parameters and a refined route solution that complies with constraints and state.

Server increases costs for edges flagged as crowded or noisy when stress is high, applies maximum distance or time limits, and adds bonuses to edges near rest or quiet facilities.

Server then recomputes or refines the route, possibly using a multi-criteria optimization to balance path length and comfort.

### Step 11:

Server performs spatial search for facilities along the route.

Server retrieves facilities that are spatially close to the computed route by executing spatial queries on facility information storage.

Input: final route geometry (polyline or list of coordinates) and facility location data.

Output: a list of facility records located within a predefined buffer distance from the route.

Server invokes a spatial index to perform a route buffer intersection, filters facilities by category and opening hours, and may compute additional attributes such as distance from a route waypoint and detour time.

### Step 12:

Server retrieves and filters promotion information.

Server identifies promotions linked to the facilities on or near the route by querying promotion information storage.

Input: facility identifiers from the facility list and current date and time.

Output: a filtered list of active promotion records associated with those facilities.

Server checks each promotion's validity period, eligibility conditions, and priority scores, discards expired or irrelevant promotions, and attaches promotion details (for example, percentage discounts and short text messages) to corresponding facilities.

### Step 13:

Server generates route-associated information as a composite object.

Server aggregates route geometry, facility information, and promotion information into a unified route-associated information structure.

Input: refined route information, filtered facility list, and filtered promotion list.

Output: a route-associated information object containing waypoints, facility entries, and linked promotion entries.

Server assigns indices for facilities along the route, computes detour times and user-preference scores, and serializes the object for efficient transmission.

### Step 14:

Server optionally generates adjusted movement plan information via the generative AI model.

Server constructs a context-rich prompt sentence that includes psychological state, route-associated information summary, and remaining time before a critical event such as departure.

Input: psychological state object, summarized facility options, and time constraints.

Output: adjusted movement plan information describing a recommended sequence of actions and optional relaxation route information and content information.

Server calls the generative AI model with a prompt such as:

“The user is highly stressed, is at node N123, has 30 minutes before boarding, and can visit these facilities: [facility summary]. Propose up to 3 steps (for example, ‘walk to lounge A, rest 10 minutes’) that fit within the time and reduce stress.”

Server parses the generated steps, maps facility names to IDs, and integrates them into specific waypoint sequences and content suggestions (for example, play calm audio).

### Step 15:

Server transmits route-associated information and adjusted movement plan to the terminal.

Server packages the composite route-associated information and any adjusted movement plan information into a response payload and sends it to the terminal.

Input: route-associated information object and optional adjusted movement plan object.

Output: a network response delivered to the terminal containing route, facility, promotion, and optional relaxation guidance.

Server may compress the payload and include version tags so the terminal can identify incremental updates.

### Step 16:

Terminal renders route and associated information to the user.

Terminal receives the server response, deserializes route geometry, facilities, and promotions, and updates the display.

Input: response payload containing route-associated information and adjusted movement plan information.

Output: visual and optional audio presentation of route, facility markers, promotion banners, and relaxation instructions.

Terminal draws the route on a map widget, places interactive icons for facilities, shows promotion messages in a list or pop-up format, and, when requested, plays relaxation content (for example, music) using local media components.

### Step 17:

User interacts with presented options and decides actions.

User views the displayed route, facilities, and promotions, and optionally taps specific facilities or suggested steps from the adjusted movement plan.

Input: visual and audio information on the terminal display.

Output: user interaction events such as selection of a facility, acceptance or rejection of a suggested plan, or a new textual query.

Terminal translates taps and gestures into structured events that it records locally and forwards to the server as feedback when appropriate.

### Step 18:

Terminal continuously updates position and sends incremental updates.

Terminal monitors position information at configured intervals, detects significant deviations from the planned route, and sends lightweight update messages to the server.

Input: successive position detections and local copy of the current route.

Output: incremental update requests containing new position vectors and deviation information.

Terminal compares current position to the nearest route segment, flags deviations beyond a threshold, and triggers transmissions only when necessary to reduce communication load.

### Step 19:

Server recalculates route and route-associated information when deviations occur.

Server receives incremental updates, checks deviation from the current route, and, when needed, recomputes route and associated data.

Input: updated position from the terminal and existing route-associated information.

Output: updated route-associated information and optional revised adjusted movement plan.

Server re-runs the route search from the new position to the destination, reuses prior facility selections where valid, performs a constrained spatial search for additional facilities, updates promotion eligibility, and sends only changed segments or deltas back to the terminal to minimize data transfer.

### Step 20:

Server collects feedback for learning and adaptation.

Server receives feedback events indicating which recommendations were followed or ignored, along with emotion-related information and movement history.

Input: feedback messages from the terminal and associated context (prompt sentence used, route configuration, psychological state).

Output: stored learning records in a learning storage for later analysis and model updates.

Server aggregates these records, indexes them by user profile and scenario type, and periodically uses them to adjust prompt-generation rules and route search parameters, thereby refining future processing and improving overall system performance.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

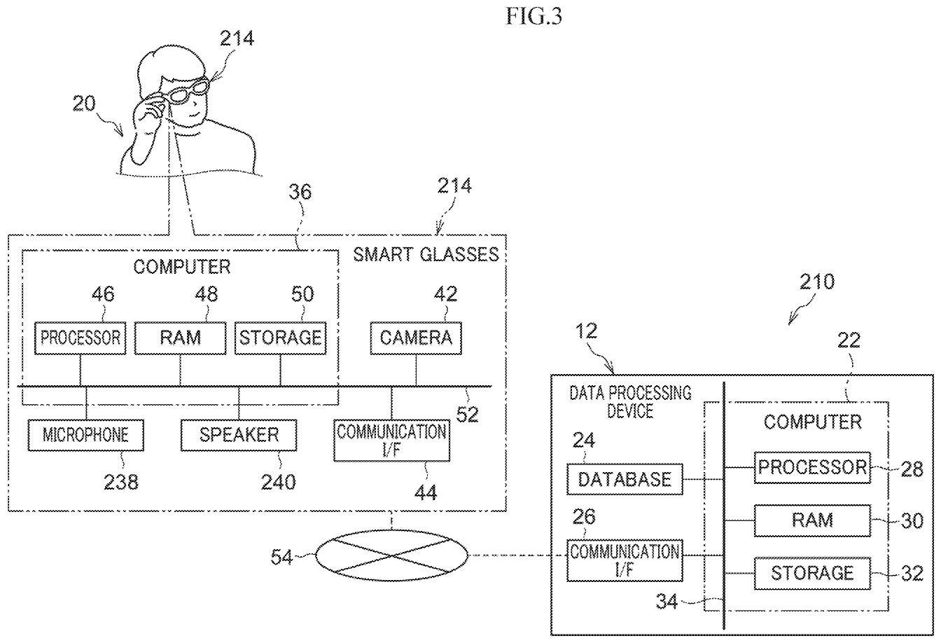

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

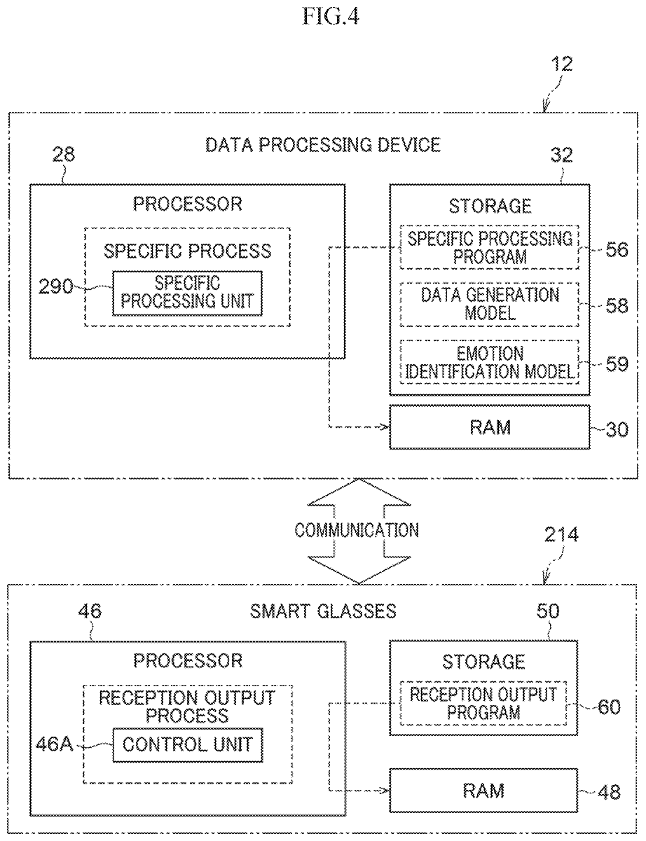

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

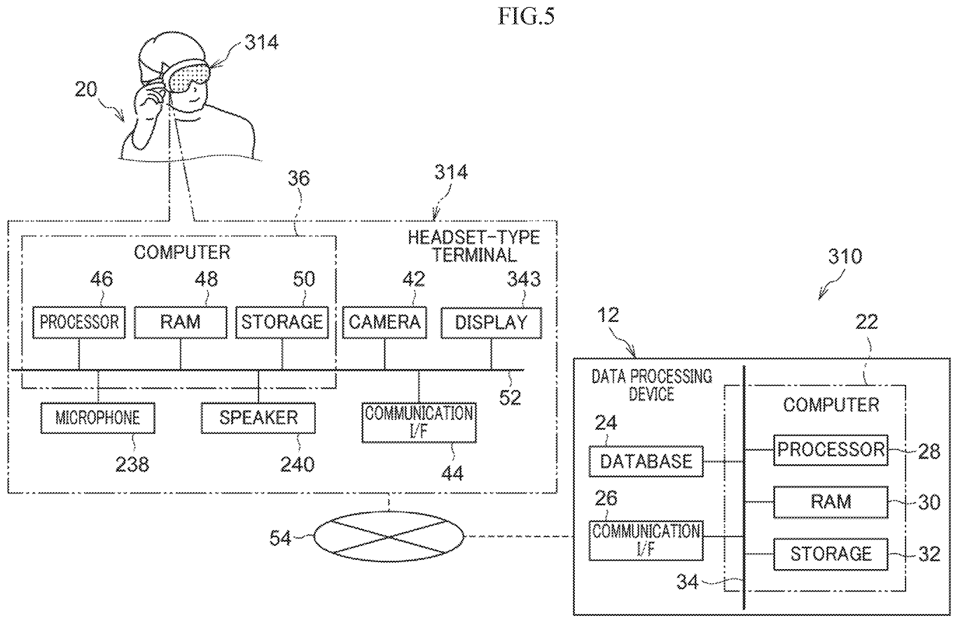

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

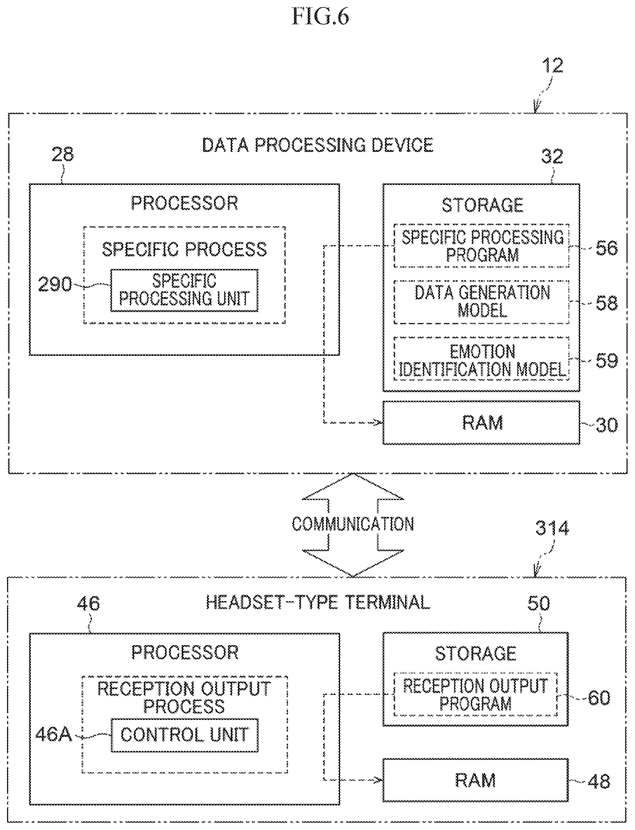

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

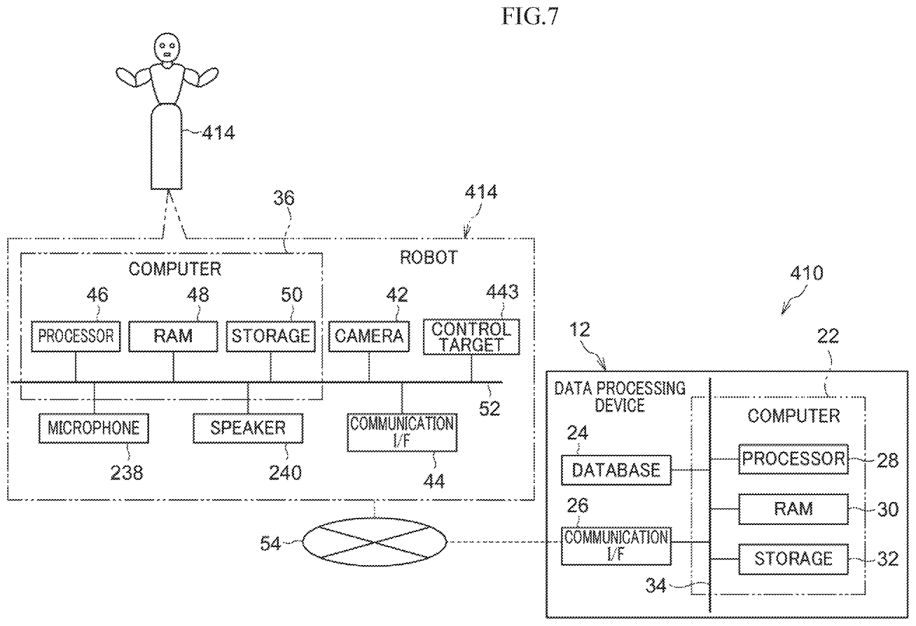

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

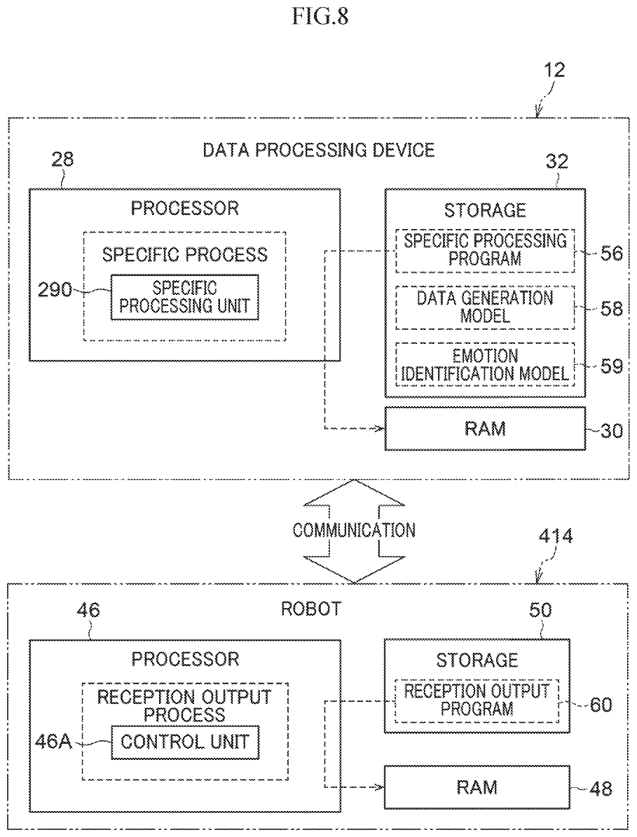

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

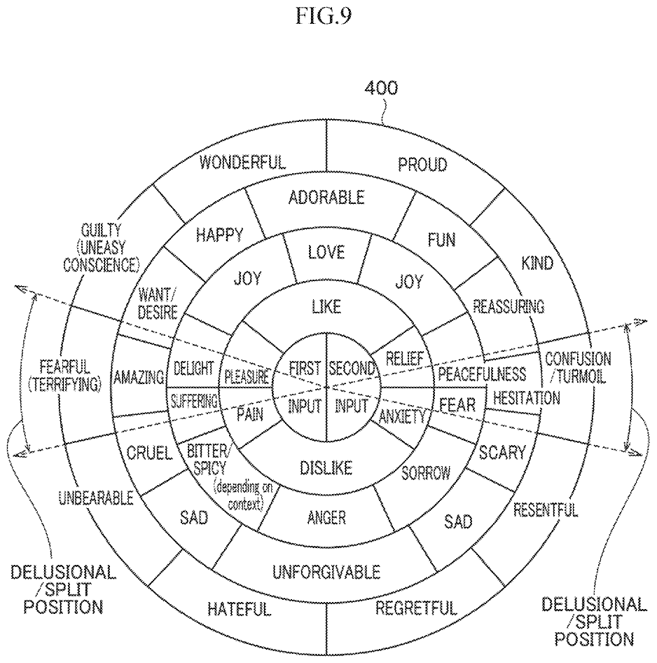

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

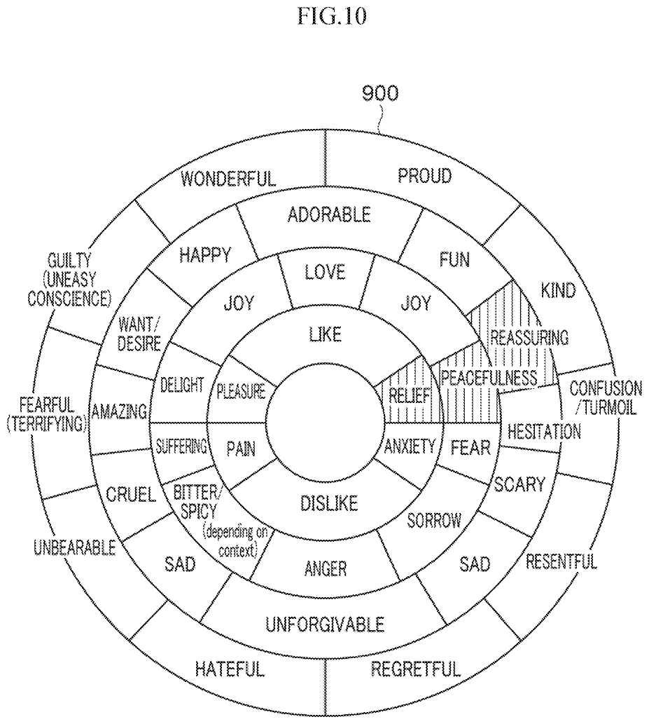

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive position-related information and movement-related requests transmitted from a user terminal,
generate a prompt sentence for input to a generative AI model based on the received position-related information and movement-related requests,
transmit the generated prompt sentence to an external generative AI model and cause the external generative AI model to perform natural language analysis and movement plan generation,
classify the position-related information and the movement-related requests into a plurality of service categories automatically, based on an analysis result received from the generative AI model,
acquire dynamic information related to a mobile object via an external communication interface, associate the dynamic information with the analysis result, and structure the associated information as movement-related information that is presentable to the user terminal,
generate, on the basis of an output result of the generative AI model and the dynamic information, a movement plan customized for an individual user in a natural language format and in a structured data format, and transmit the movement plan to the user terminal, calculate, based on position-related information acquired from an indoor positioning unit and route data representing a structure of a facility, a route from a current position to a destination within the facility by performing a route search process, and transmit the route to the user terminal so that guidance information is displayed on the user terminal,
format at least a part of the movement plan and the route within the facility into stepwise action instructions based on natural language text output by the generative AI model, and present the stepwise action instructions as time-series procedure information that a user can follow, and
store operation history information and response history information of the user, and, based on the stored history information, sequentially adjust contents of generating the prompt sentence and a presentation format of the movement plan.

### (Supplementary 2)

The system according to supplementary 1,
wherein the processor is configured to
summarize the position-related information and the movement-related requests in order to automatically identify a relevant service category, generate a service-identification prompt sentence based on the summary, cause the generative AI model to estimate, in response to the service-identification prompt sentence, a type and a priority of a related service, and perform classification processing into the plurality of service categories based on an estimation result.

### (Supplementary 3)

The system according to supplementary 1,
wherein the processor is configured to
acquire the position-related information periodically transmitted from the user terminal, update a movement state of the user over time using the position-related information, recalculate route information to the destination, when a deviation from the route exceeds a predetermined threshold, update the prompt sentence for the generative AI model to instruct generation of a new movement plan, and sequentially transmit the updated route information and the updated movement plan to the user terminal.

### Application Example 1

### (Supplementary 1)

A system comprising a processor,
wherein the processor is configured to
receive position information and movement request information transmitted from a user information processing device,
acquire environment information including traffic information and weather information from an external information providing device based on the received position information and movement request information,
generate route candidate information representing a movement route based on the acquired environment information and the movement request information, and calculate optimized route information by performing weighting for each road section in accordance with a congestion level and a weather condition,
generate a prompt sentence for input to a generative AI model on the basis of the optimized route information, a situation description information item summarizing the environment information, user attribute information, and constraint condition information, transmit the prompt sentence to the generative AI model and obtain movement plan description information including evaluation information and explanation information for the optimized route information from the generative AI model,
generate movement plan information by associating the movement plan description information with the optimized route information, and transmit the movement plan information to the user information processing device,
receive selection information or change request information for a plurality of presented movement plan information items from the user information processing device, and reflect the selection information or the change request information as the constraint condition information in regeneration of the prompt sentence and regeneration of the optimized route information,
monitor a change of the environment information, and when a change in a traffic situation or a weather situation exceeding a predetermined threshold is detected, recalculate the optimized route information and generate an update prompt sentence including content representing the change, input the update prompt sentence to the generative AI model, obtain updated movement plan description information, and notify the updated movement plan description information to the user information processing device, and
record the optimized route information and the movement plan description information for each user and each time, estimate a route preference of the user on the basis of the record, and adjust the weighting and generation conditions of the prompt sentence.

### (Supplementary 2)

The system according to supplementary 1,
wherein the processor is configured to automatically generate the prompt sentence from structured data including the optimized route information, the environment information, and the user attribute information, and to include, in the prompt sentence, instruction content requesting the generative AI model to specify a recommended route, enumerate alternative routes, and describe advantages and disadvantages of each route.

### (Supplementary 3)

The system according to supplementary 1,
wherein the processor is configured to cause the user information processing device, based on the movement plan information, to visually superimpose the optimized route information on a map image on a display device, to additionally display the movement plan description information as text information, and, in response to an operation input from the user, to switch display among different movement plan information items and to transmit the selection information to the system.

### Example 2

### (Supplementary 1)

A system comprising a processor,
wherein the processor is configured to
receive position information and movement request information transmitted from a user terminal device,
identify a current position of a user by integrating a plurality of types of position data including positioning information from a positioning device and signal strength information from a short-range wireless signal generation device, in order to associate the received position information with route information stored in a spatial information storage device, refer to route structure information representing indoor passage sections, connection points, and elevation means, and perform route search processing using an evaluation function that applies weights to distance information, required time information, congestion information, and usage condition information based on the movement request information and the current position, so as to calculate optimal route information to a destination,
acquire moving body operation information, boarding point information, delay information, and time information from an external information provision device, calculate movement margin time for the user by integrating the optimal route information with the acquired information, dynamically update the evaluation function in accordance with the movement margin time, and generate movement plan information adapted to the user,
generate structured data including route section information, movement distance information, required time information, facility information, and support information within a facility by using the optimal route information and the movement plan information, and generate a prompt sentence that designates the structured data as a description target,
input the prompt sentence and the structured data into a generative AI model and cause the generative AI model to generate natural language response information including guidance text, explanatory text, and support text to be presented to the user,
transmit the natural language response information and the optimal route information to the user terminal device,
receive, as a prompt sentence, a free-form inquiry text transmitted from the user terminal device, generate context information including the inquiry text, the current position, the optimal route information, and the movement plan information, and input the context information into the generative AI model to cause the generative AI model to generate response information and route change guidance information according to a situation of the user,
generate updated route information by associating recalculated route information, obtained by re-executing the route search processing based on contents of the response information output from the generative AI model, with the route change guidance information, and transmit the updated route information to the user terminal device, and
analyze state information and operation history information of the user and change contents of a provided service by adjusting contents of the prompt sentence input to the generative AI model and an expression style of the natural language response information output from the generative AI model.

### (Supplementary 2)

The system according to supplementary 1,
wherein the processor is configured to, in generating the prompt sentence to be input to the generative AI model, add instruction information indicating a service category, a guidance type, and a support type related to contents of a plurality of types of information including the position information and the movement request information acquired from the user, the inquiry text, and the moving body operation information acquired from the external information provision device, to the prompt sentence, cause the generative AI model to analyze the plurality of types of information based on the instruction information, and automatically associate the information with a service function in accordance with an analysis result.

### (Supplementary 3)

The system according to supplementary 1,
wherein the processor is configured to receive current position information periodically transmitted from the user terminal device, perform deviation determination processing based on a positional relationship between the current position information and the optimal route information, when route deviation or destination change is detected by the deviation determination processing, re-execute the route search processing to calculate new optimal route information, regenerate the prompt sentence based on structured data including the new optimal route information and latest moving body operation information, input the regenerated prompt sentence to the generative AI model to cause the generative AI model to generate an updated guidance text, and transmit the new optimal route information and the updated guidance text to the user terminal device in real time.

### Application Example 2

### (Supplementary 1)

A system comprising a processor,
wherein the processor is configured to
receive position information and movement request information transmitted from a user terminal device,
generate a prompt sentence for a generative AI model based on the received position information and movement request information, input the prompt sentence into the generative AI model, cause the generative AI model to analyze natural language information including the movement request information, and extract destination information and user attribute information,
calculate route information from a current position to a destination based on the extracted destination information by using route network data stored in a geographic information storage and a route search algorithm, acquire operation information of a moving body along the route information via an external information providing apparatus, generate real-time moving body information, and notify the user terminal device of the real-time moving body information,
acquire facility information located in proximity to the route information by performing spatial search on a facility information storage based on the route information, acquire promotion information from a promotion information storage associated with the facility information, and associate the promotion information with the route information, generate route-associated information by integrating the route information, the facility information, and the promotion information, and transmit the route-associated information to the user terminal device,
successively update the current position based on measurement information from a position detection device obtained from the user terminal device, and, when the current position deviates from the route information by more than a predetermined condition, recalculate the route information and the route-associated information and transmit update information to the user terminal device,
estimate a psychological state of a user based on biometric information obtained from a biometric information acquisition device and emotion information obtained from an emotion state recognition device, and, when the psychological state satisfies a predetermined condition, generate a prompt sentence for the generative AI model, input the psychological state and the facility information into the generative AI model, and cause the generative AI model to generate adjusted movement plan information including relaxation route information and relaxation content information,
adjust a service to present, to the user terminal device, at least one of rest facility information, quiet environment information, and calming presentation information based on the adjusted movement plan information,
accumulate emotion-related information, movement history information, and service selection information obtained from the user terminal device in a learning storage, and, based on accumulated information, update generation rules of prompt sentences for the generative AI model and parameters of the route search algorithm so as to adaptively improve subsequent route proposals and information provision,
automatically classify the movement request information, based on analysis results, into at least one of a real-time moving body information providing service, a movement plan generation service, a facility guidance service, a surrounding information providing service, and a trouble response support service, and determine a service type and presentation content to be provided to the user terminal device according to a classification result, and
when problem occurrence information is received, generate, based on the classification result and an output of the generative AI model, at least one of alternative route information, alternative movement means information, and support information, and present the at least one of the alternative route information, the alternative movement means information, and the support information to the user terminal device.

### (Supplementary 2)

The system according to supplementary 1,
wherein the processor is configured to
generate a plurality of types of prompt sentences for the generative AI model using context information including an emotion state of a user, a psychological state estimated from biometric information, the route information, and the facility information, input the plurality of types of prompt sentences into the generative AI model, compare and evaluate output results corresponding to the plurality of types of prompt sentences, and select guidance information, promotion information, or relaxation information to be presented to the user terminal device.

### (Supplementary 3)

The system according to supplementary 1,
wherein the processor is configured to
generate a prompt sentence for the generative AI model from a natural language inquiry sentence of the user, input the prompt sentence into the generative AI model to extract, from the inquiry sentence, a time condition, a movement constraint condition, and a preference condition, apply the time condition, the movement constraint condition, and the preference condition to the facility information storage and the route network data to calculate ranking of candidate visit locations and recommendation reason information, and provide, to the user terminal device, guidance route information for the candidate visit locations together with the ranking and the recommendation reason information.

What is claimed is:

1. A system comprising:
circuitry configured to:
receive, via a communication interface coupled to a packet-switched network, position-related data and movement-related request data from a terminal device;
generate, using a generative neural network model, a prompt sentence encoding the position-related data and movement-related request data as analysis instructions for extraction of relevant information;
input the prompt sentence to the generative neural network model to extract service-classification data from the movement-related request data;
classify the service-classification data into one or more service categories based on an output of the generative neural network model;
acquire dynamic mobile-object status data from an external data service via the communication interface, and transmit a notification derived from the dynamic mobile-object status data to the terminal device;
generate a movement plan by inputting contextual data to the generative neural network model and structuring an output of the generative neural network model into time-ordered action instructions;
compute a route within a facility using a route search algorithm applied to route network data, and transmit route guidance data derived from the route to the terminal device;
acquire facility-vicinity data and transmit the facility-vicinity data to the terminal device; and
receive an emotion state parameter derived from input signals of a user, and adjust at least one of content, presentation format, or notification frequency of output data based on the emotion state parameter.

2. The system according to claim 1, wherein the circuitry is configured to generate a service-identification prompt sentence specifying instructions for identifying a service category from the movement-related request data, input the service-identification prompt sentence to the generative neural network model, and determine the service category based on an output of the generative neural network model.

3. The system according to claim 2, wherein the circuitry is configured to select a prompt template from a plurality of prompt templates based on a type of the movement-related request data, substitute normalized feature values derived from the position-related data and the movement-related request data into the prompt template to generate the service-identification prompt sentence, and store the normalized feature values in an intermediate data structure prior to template substitution.

4. The system according to claim 3, wherein the circuitry is configured to receive a plurality of types of prompt sentences processed by the generative neural network model using context data including the emotion state parameter and the route network data, evaluate output results corresponding to the plurality of types of prompt sentences, and select guidance data, promotional data, or relaxation data for transmission to the terminal device based on the evaluation.

5. The system according to claim 4, wherein the circuitry is configured to classify the service-classification data into at least one of a real-time mobile-object information providing service, a movement plan generation service, a facility guidance service, a facility-vicinity information providing service, and a trouble support service, and determine presentation content for the terminal device based on a classification result.

6. The system according to claim 1, wherein the circuitry is configured to update position data of the user based on current position-related data received from the terminal device, apply a pathfinding algorithm to the route network data to determine an updated route from a current position to a destination, and transmit route guidance data corresponding to the updated route to the terminal device.

7. The system according to claim 6, wherein the circuitry is configured to compute a deviation metric by comparing the current position-related data against a planned route, determine that the deviation metric exceeds a predetermined threshold, and regenerate the movement plan by generating a revised prompt sentence and inputting the revised prompt sentence to the generative neural network model.

8. The system according to claim 7, wherein the circuitry is configured to store operation history data and response history data in a memory, apply an adaptation algorithm to the stored operation history data and response history data to adjust one or more prompt template parameters, and generate subsequent prompt sentences using the adjusted prompt template parameters.

9. The system according to claim 8, wherein the circuitry is configured to store movement-related request data, operation history data, and service-selection data in a learning storage, and update prompt-generation parameters and route search algorithm parameters based on the stored data to adaptively refine subsequent movement plan generation.

10. The system according to claim 1, wherein the circuitry is configured to receive problem-occurrence data from the terminal device, generate at least one of alternative route data, alternative movement means data, or trouble support data based on the service-classification data and an output of the generative neural network model, and transmit the generated data to the terminal device.

11. The system according to claim 10, wherein the circuitry is configured to parse natural language output of the generative neural network model using a text-structure extraction module to identify step markers, segment the natural language output into discrete step elements each comprising a step index, an action type, and a time interval, and store the discrete step elements as structured data associated with a user session.

12. The system according to claim 11, wherein the circuitry is configured to verify internal consistency of the structured data by checking that a sum of the time intervals of the discrete step elements does not exceed an available time window, and regenerate at least a portion of the movement plan when an inconsistency is detected.

13. The system according to claim 1, wherein the circuitry is configured to receive biometric input data from the terminal device, apply an emotion identification model to the biometric input data to generate the emotion state parameter, and adjust a tone, level of detail, or notification frequency of transmitted data based on the emotion state parameter.

14. The system according to claim 13, wherein the circuitry is configured to map the emotion state parameter to a position on an emotion map that associates affective states with presentation adjustments, and select guidance data, facility-vicinity data, or relaxation data for transmission to the terminal device based on the position on the emotion map.

15. The system according to claim 1, wherein the circuitry is configured to receive a natural language inquiry from the terminal device, generate a prompt sentence from the natural language inquiry specifying a time condition, a movement constraint condition, and a preference condition, input the prompt sentence to the generative neural network model to extract the time condition, the movement constraint condition, and the preference condition, apply the extracted conditions to facility data stored in a memory to compute a ranked list of candidate destination data, and transmit the ranked list together with recommendation reason data to the terminal device.

16. The system according to claim 1, wherein the circuitry is configured to merge the dynamic mobile-object status data with the movement plan by adjusting time estimates in the movement plan when the dynamic mobile-object status data conflicts with initial timing assumptions, and transmit an updated movement plan to the terminal device.

17. The system according to claim 1, wherein the circuitry is configured to receive position-related data including indoor coordinates derived from a positioning unit using wireless signals, map the indoor coordinates to a node of a route graph, apply a shortest-path algorithm to the route graph using a cost function incorporating distance, estimated traversal time, and accessibility constraints, and generate stepwise action instructions from a resulting sequence of waypoints.

18. A system comprising:
circuitry configured to:
receive, via a communication interface coupled to a packet-switched network, position-related data and movement-related request data from a terminal device;
parse the position-related data and the movement-related request data using a feature-extraction algorithm to generate normalized feature values;
select a prompt template from a plurality of templates based on a request type, substitute the normalized feature values into the prompt template to produce a prompt sentence, and input the prompt sentence to a generative neural network model via the communication interface;
receive a structured output of the generative neural network model and convert the structured output into time-ordered action instructions by segmenting the output at structural markers and associating each segment with an action type, a start time, and an end time;
acquire dynamic mobile-object status data from an external data service and merge the dynamic mobile-object status data with the time-ordered action instructions by adjusting time estimates when a conflict is detected; and
compute a route using a pathfinding algorithm applied to route graph data and transmit route guidance data and the time-ordered action instructions to the terminal device.

19. The system according to claim 18, wherein the circuitry is configured to receive an emotion state parameter derived from input signals of a user, apply an emotion identification model to generate a classified emotion state, and adjust at least one of content, tone, or notification frequency of output data based on the classified emotion state.

20. A method performed by circuitry, the method comprising:
receiving, via a communication interface coupled to a packet-switched network, position-related data and movement-related request data from a terminal device;
generating, using a generative neural network model, a prompt sentence encoding the position-related data and movement-related request data as analysis instructions for extraction of relevant information;
inputting the prompt sentence to the generative neural network model to extract service-classification data from the movement-related request data;
classifying the service-classification data into one or more service categories based on an output of the generative neural network model;
acquiring dynamic mobile-object status data from an external data service via the communication interface, and transmitting a notification derived from the dynamic mobile-object status data to the terminal device;
generating a movement plan by inputting contextual data to the generative neural network model and structuring an output of the generative neural network model into time-ordered action instructions;
computing a route within a facility using a route search algorithm applied to route network data, and transmitting route guidance data derived from the route to the terminal device;
acquiring facility-vicinity data and transmitting the facility-vicinity data to the terminal device; and
receiving an emotion state parameter derived from input signals of a user, and adjusting at least one of content, presentation format, or notification frequency of output data based on the emotion state parameter.
